(19) United States
(12) Patent Application Publication
(10) Pub. No.: US 2024/0083286 A1
(43) Pub. Date: Mar. 14, 2024

(54) INFORMATION PROCESSING DEVICE, CHARGING DEVICE, AND CHARGING SYSTEM

(71) Applicant: SONY GROUP CORPORATION, TOKYO (JP)

(72) Inventor: YOICHIRO MIZUNO, TOKYO (JP)

(21) Appl. No.: 18/259,798

(22) PCT Filed: Jan. 7, 2021
(86) PCT No.: PCT/JP2021/000377

§ 371 Date: Jun. 29, 2023

(51) Int. Cl. B60L 53/65; B60L 53/66; B60L 53/68

(52) U.S. Cl. CPC B60L 53/65; B60L 53/665; B60L 53/68; B60L 2250/16

(57) ABSTRACT

An information processing device includes an acquisition unit that acquires information related to a charging device that receives power from a power supply facility and supplies the power, the charging device being separated from the power supply facility; a determination unit that determines permission or non-permission of the power supply of the charging device based on the information related to the charging device; and a transmission unit that transmits information related to a determination result of permission or non-permission of the power supply to the charging device or another device that controls the charging device.

### FIELD

The present disclosure relates to an information processing device, a charging device, and a charging system.

### BACKGROUND

Charging demand inside and outside home is expanding. For example, in recent years, demands for charging facilities for charging an electric vehicle (EV) have been expanded under the spread and promotion of the EV.

### CITATION LIST

### Patent Literature

Patent Literature 1: JP2020-18104A

### SUMMARY

### Technical Problem

When charging facilities become widespread, a device using the charging facilities (for example, an EV) can also be expected to become widespread. However, installation of charging facilities requires a large amount of investment. In particular, an extremely large amount of investment is required for a charging facility of an EV. If the charging facilities do not become widespread, devices using the charging facilities cannot be expected to become widespread.

Therefore, the present disclosure proposes an information processing device, a charging device, and a charging system capable of realizing charging environments at a low cost.

### Solution to Problem

To solve the problems described above, an information processing device according to an embodiment of the present disclosure includes: an acquisition unit that acquires information related to a charging device that receives power from a power supply facility and supplies the power, the charging device being separated from the power supply facility; a determination unit that determines permission or non-permission of the power supply of the charging device based on the information related to the charging device; and a transmission unit that transmits information related to a determination result of permission or non-permission of the power supply to the charging device or another device that controls the charging device.

### BRIEF DESCRIPTION OF DRAWINGS

FIG. 1 is a diagram illustrating an outline of a charging system of the present embodiment.

FIG. 2 is a diagram illustrating a configuration example of the charging system according to the embodiment of the present disclosure.

FIG. 3 is a diagram illustrating a configuration example of a charging management server according to the embodiment of the present disclosure.

FIG. 4 is a diagram illustrating a configuration example of a service server according to the embodiment of the present disclosure.

FIG. 5 is a diagram illustrating a configuration example of a power contractor management server which is an example of the service server.

FIG. 6 is a diagram illustrating a configuration example of a member information management server which is an example of the service server.

FIG. 7 is a diagram illustrating a configuration example of a parking lot management server which is an example of the service server.

FIG. 8 is a diagram illustrating a configuration example of a terminal device according to the embodiment of the present disclosure.

FIG. 9 is a diagram illustrating a configuration example of a charging device according to the embodiment of the present disclosure.

FIG. 10 is a diagram illustrating a configuration example of a power supply facility according to the embodiment of the present disclosure.

FIG. 11 is a diagram illustrating a configuration example of a moving body according to the embodiment of the present disclosure.

FIG. 12 is a flowchart illustrating a charging management process according to the present embodiment.

FIG. 13 is a diagram illustrating an example of an operation of the charging system at the start of charging.

FIG. 14 is a diagram illustrating an example of an operation of the charging system during charging.

FIG. 15 is a diagram illustrating an example of an operation of the charging system at the end of charging.

FIG. 16 is a diagram illustrating an example of an operation of the charging system at the time of billing to a user.

FIG. 17 is a flowchart illustrating a first charging control process.

FIG. 18 is a flowchart illustrating a second charging control process.

FIG. 19 is a flowchart illustrating a third charging control process.

FIG. 20 is a diagram illustrating system collaboration of a charging infrastructure service.

### DESCRIPTION OF EMBODIMENTS

Hereinafter, embodiments of the present disclosure are described in detail based on the accompanying drawings. In each of the following embodiments, the same parts are denoted by the same reference numerals, and redundant description will be omitted.

In addition, in the present specification and the drawings, a plurality of configurations having substantially the same functional configuration may be distinguished by attaching different numerals after the same reference numerals. For example, a plurality of configurations having substantially the same functional configuration are distinguished as power supply facilities 501 and 502 as necessary. Note that, when it is not necessary to particularly distinguish a plurality of components having substantially the same functional configuration, only the same reference numeral is assigned. For example, when it is not necessary to particularly distinguish the power supply facilities 501 and 502, the same is simply referred to as power supply facilities 50.

In addition, the present disclosure will be described according to the following item order.
1. Outline of Present Embodiment
2. Configuration of Charging System
2-1. Configuration of Charging Management Server
2-2. Configuration of Service Server
2-3. Configuration of Terminal Device
2-4. Configuration of Charging Device
2-5. Configuration of Power Supply Facility
2-6. Configuration of Moving Body
3. Operation of Charging System
3-1. Charging Management Process
3-2. Determination on Power Supply Availability
3-3. Operation Example at Start of Charging
3-4. Operation Example During Charging
3-5. Operation Example at End of Charging
3-6. Operation Example at Time of Billing to User
4. Charging Control Operation of Charging Device
4-1. First Charging Control Process
4-2. Second Charging Control Process
4-3. Third Charging Control Process
5. System Collaboration of Charging Infrastructure Service
6. Method of Using Charging Infrastructure Service
7. Modification
7-1. Modification related to Charging Target
7-2. Modification related to Charging Standard
7-3. Modification related to Determination on Power Supply
Availability
7-4. Modification related to Position Information of
Charging Device
7-5. Other Modifications
8. Conclusion

### 1. OUTLINE OF PRESENT EMBODIMENT

In recent years, with the tightening of CO₂ emission regulations, the spread and expansion of electric vehicles (EVs) have been promoted. In order to spread EVs, it is necessary to spread a charging facility for charging EVs (for example, an EV charger). However, in order to newly install charging facilities, a large amount of investment is required. For example, an existing EV charger such as a CHAdeMO (Registered Trademark) DC quick charger is sold on the premise of installation work and implementation of electric work and thus is extremely expensive. Moreover, in order to newly install an EV charger, new investment in a power transmission facility is also required.

In addition, in order to use an existing EV charger, initial registration to the EV charging infrastructure service and a payment medium such as an NFC card are required. In addition, since operation procedures of the existing EV charger are different for each of charger manufacturers/models/services, a user has to check whether a service can be used and the operation procedure, whenever the user goes to the place where the EV charger is installed. That is, the use of the existing EV charger requires not only expense but also cost (temporal cost and procedural cost) such as time and labor.

Note that an existing EV charging method (for example, CHAdeMO method DC quick charging method. Hereinafter, it is simply referred to as a CHAdeMO system) is a specification obtained by assuming an output power of about 10 kW or more. Therefore, it is not assumed that the existing EV charger is connected to an AC power supply with low power (for example, about 3 kW or less). If the EV charger is configured to operate with an AC power supply with low power (for example, commercial AC outlet) of 3 kW or less, the EV user can charge the EV using the AC power supply in a place other than the power contract address. In this case, an electricity rate is charged to the establishment owner or the establishment administrator of the place. That is, if the EV charger can use a low-power AC power supply that is most widely used at present, in some cases, a malicious EV user can charge an EV without paying an electricity rate.

Therefore, in the present embodiment, the above problem is solved by the following means.

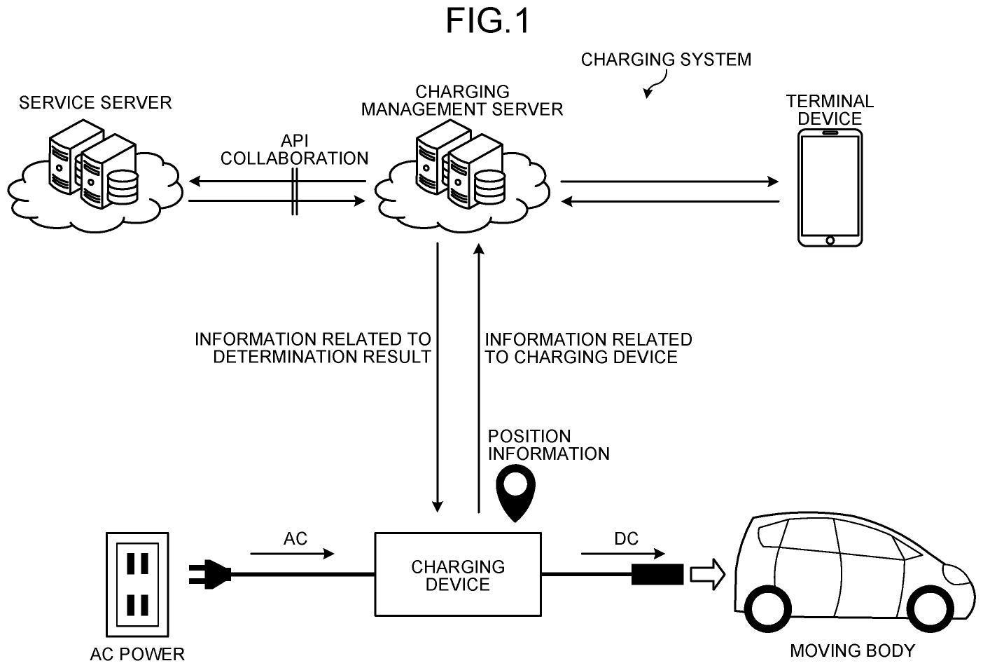

FIG. 1 is a diagram illustrating an outline of a charging system of the present embodiment. The charging system of the present embodiment is a system for charging a moving body (for example, an EV). A charging device illustrated in FIG. 1 is a device that receives power from a power supply facility (for example, commercial AC power supply) and supplies the power to a moving body, and is a portable charger separate from the power supply facility. Here, the power supply facility may be an existing facility. For example, the power supply facility may be an AC power supply (AC outlet) installed in a general house or may be an on-road outlet installed on a road. Of course, the power supply facility may be a power supply facility for charging installed in a predetermined establishment (for example, a parking lot, a gas station, and a service area of a highway).

The charging device of the present embodiment includes, for example, an AC plug that can be inserted into and removed from an AC power supply (for example, an AC outlet illustrated in FIG. 1) and a connector that can be connected to a charging target. In the example of FIG. 1, the device to be charged is a moving body (for example, an EV) and includes an inlet conforming to a predetermined charging standard. The predetermined charging standard is, for example, CHAdeMO. In the example of FIG. 1, the connector included in the charging device is a connector conforming to a predetermined charging standard and can be connected to the inlet included in the moving body. The charging device converts AC power supplied from the AC power supply into DC power and supplies the DC power to the moving body via the connector and the inlet.

The charging device of the present embodiment is configured such that the above power supply operation (also referred to as a charging operation) can be controlled by an external device so that existing power supply facilities can be effectively used. More specifically, the charging device is configured such that the charging management server (or a service server) illustrated in FIG. 1 can control the above power supply operation. Hereinafter, control of the charging device by the charging management server is described with reference to FIG. 1.

The charging device has a communication function and is connected to the charging management server via a network. The network may be a wireless network or may be a wired network. When the user connects the AC plug of the charging device to the AC power supply and connects the connector of the charging device to the inlet of the moving body, the charging device transmits information related to the charging device to the charging management server via the network. As the information to be transmitted, ID information of the charging device and position information of the charging device are assumed. The position information may be global positioning system (GPS) information indicating the position of the charging device.

Subsequently, the charging management server determines permission or non-permission (hereinafter, it is also referred to as power supply availability) of the power supply operation of the corresponding charging device based on the information related to the charging device. For example, in a case where the position of the charging device is located at the installation place of the power supply facility available to the user (for example, the user's home or the user's contract parking lot), the charging management server permits power supply to the corresponding charging device. Note that, in addition to the position information, the charging management server may use history information and payment record information of the user associated with the ID information of the charging device as the determination information for determining power supply availability.

Note that the charging management server may determine power supply availability based on information provided from the service server. Here, the service server may be a remote operation server that remotely operates the charging device. As an example of the remote operation server, a power contractor management server that manages power contractor information is assumed. When the service server is a server that performs a power-related process such as a power contractor management server, for example, alarm information indicating that the limit of the power supply capability is close is assumed as the information provided by the service server.

Note that power supply availability may be determined by the service server. Then, the service server may transmit information related to the determination result (for example, the charging control information based on the determination result) to the charging device via the charging management server. When the service server is the power contractor management system, the following (1) to (4) can be assumed as the determination condition of power supply availability.
(1) The user associated with the ID information of the charging device has payment ability.
(2) Surplus power in total power supply amount related to supply limit value is sufficient.
(3) The user or the establishment administrator secures the right to use power at the time of EV charging by future transaction or the like.
(4) The user reserves a place, time, and power consumption amount.

Then, the charging management server transmits information related to the determination result of power supply availability to the charging device. The information related to the determination result may be control information for controlling the charging device or may be simply notification information for notifying the determination result. As examples of the notification information, power supply permission information and power supply prohibition information are assumed. If the charging device operates according to the notification, the notification information can be regarded as the control information.

Subsequently, the charging management server performs a billing process for the user associated with the ID information of the charging device. Note that the billing process may be performed by the service server. For example, it is assumed that the service server is a power contractor management server. In this case, the power contractor management server adds the power consumption amount of the charging device to the power consumption amount at the address on the power contract of the user and bills the user for an electricity rate corresponding to the added power amount. As a result, not the administrator of the power supply facility but the user who actually uses the power supply facility can be charged for the electricity rate.

With the charging system of the present embodiment, since the power supply of the charging device is controlled by an external device, the user can charge the moving body using the existing power supply facility. That is, since it is not necessary to newly prepare an expensive power supply facility, a charging environment can be realized at a low cost. In addition, since the charging device can be carried to a place where there is a power supply facility, the user does not take a labor of checking availability of the service and an operation procedure each time the charging is performed.

The outline of the present embodiment is described above, and the charging system according to the present embodiment is described in detail below.

### 2. CONFIGURATION OF CHARGING SYSTEM

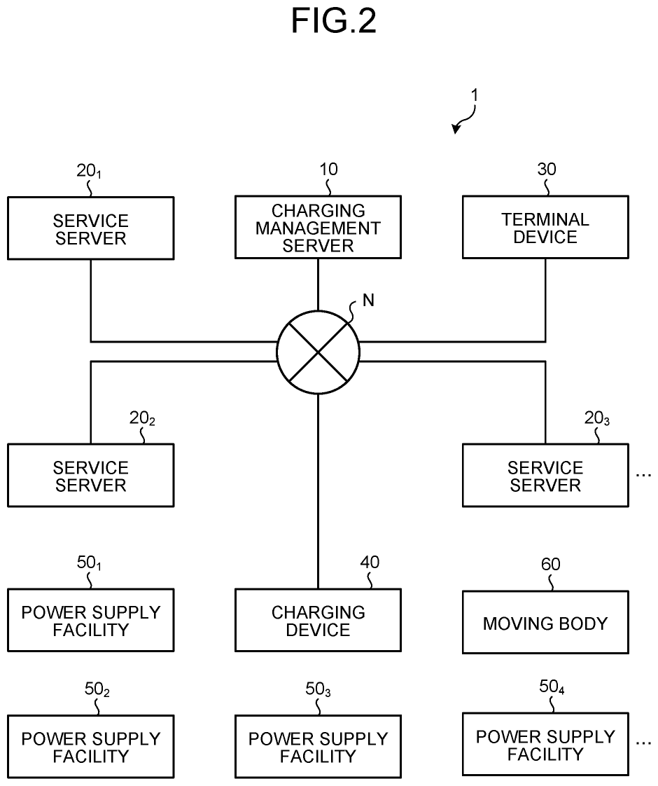

FIG. 2 is a diagram illustrating a configuration example of a charging system 1 according to the embodiment of the present disclosure. The charging system 1 is a system for charging a charging target. In the present embodiment, the charging target is a moving body, but a moving target may not necessarily be a moving body.

The charging system 1 includes a charging management server 10, a service server 20, a terminal device 30, a charging device 40, a power supply facility 50, and a moving body 60. Note that devices in the drawings may be considered as devices in a logical sense. That is, a part of the device in the drawing may be realized by a virtual machine (VM), a container, a docker, and the like, and the virtual machine (VM), the container, the docker, and the like may be implemented on physically the same hardware.

The charging management server 10, the service server 20, the terminal device 30, and the charging device 40 each have a communication function and are connected to each other via a network N. In the following description, the charging management server 10, the service server 20, the terminal device 30, and the charging device 40 may be referred to as communication devices. As long as the power supply facility 50 and the moving body 60 each have a communication function, the power supply facility 50 and the moving body 60 can also be regarded as a type of communication device. In this case, the power supply facility 50 and the moving body 60 may be connectable to the network N. Although only one network N is illustrated in the example of FIG. 2, a plurality of networks N may exist.

Here, the network N is a communication network such as a local area network (LAN), a wide area network (WAN), a cellular network, a fixed telephone network, a regional Internet protocol (IP) network, or the Internet. The network N may include a wired network or may include a wireless network. In addition, the network N may include a core network. The core network is, for example, an evolved packet core (EPC) or a 5G core network (5GC). In addition, the network N may include a data network other than the core network. For example, the data network may be a service network of a telecommunications carrier, for example, an IP multimedia subsystem (IMS) network. Furthermore, the data network may be a private network such as an intra-company network.

The communication device such as the charging device 40 may be connected to the network N using a radio access technology (RAT) such as long term evolution (LTE), new radio (NR), Wi-Fi, or Bluetooth (Registered Trademark). At this time, the communication device may be configured to be able to use different radio access technologies. For example, the communication device may be configured to be able to use NR and Wi-Fi. Furthermore, the communication device may be configured to be able to use different cellular communication technologies (for example, LTE and NR). LTE and NR are a type of cellular communication technology and enable mobile communication of communication devices such as the terminal device 30 and the charging device 40 by arranging a plurality of areas covered by a base station in a cell shape.

Note that, in the following description, “LTE” includes LTE-Advanced (LTE-A), LTE-Advanced Pro (LTE-A Pro), and evolved universal terrestrial radio access (EUTRA). In addition, the NR includes new radio access technology (NKAT) and Further EUTRA (FEUTRA). Note that a single base station may manage a plurality of cells. In the following description, a cell corresponding to LTE is referred to as an LTE cell, and a cell corresponding to NR is referred to as an NR cell.

The NR is a radio access technology of a next generation (fifth generation) of LTE (fourth generation communication including LTE-Advanced and LTE-Advanced Pro). The NR is a radio access technology that can support various use cases including enhanced mobile broadband (eMBB), massive machine type communications (mMTC), and ultra-reliable and low latency communications (URLLC). The NR has been studied aiming at a technical framework corresponding to usage scenarios, requirement conditions, arrangement scenarios, and the like in these use cases.

Note that the communication device such as the charging device 40 may be connectable to the network N using a radio access technology other than LTE, NR, Wi-Fi, and Bluetooth. For example, the communication device may be connectable to the network N by using low power wide area (LPWA) communication.

Here, LPWA communication is radio communication that enables low-power wide-range communication. For example, the LPWA radio is Internet of Things (IoT) radio communication using a specified low power radio (for example, the 920 MHz band) or an industry-science-medical (ISM) band. Note that the LPWA communication used by the communication device such as the charging device 40 may conform to the LPWA standard. Examples of the LPWA standard include ELTRES, ZETA, SIGFOX, LoRaWAN, and NB-Iot. Of course, the LPWA standard is not limited thereto and may be other LPWA standards.

Furthermore, a communication device such as the charging device 40 may be connectable to the network N using power line communication (PLC). Here, power line communication (PLC) is communication using a power line as a communication path and is also referred to as power line telecommunication (PLT). In addition, the communication device may be connectable to the network N by using a communication technology of a proprietary standard.

Hereinafter, a configuration of each device that configures the charging system 1 is specifically described. Note that the configuration of each device described below is merely an example. The configuration of each device may be different from the following configuration.

<2-1. Configuration of Charging Management Server>

First, a configuration of the charging management server 10 is described.

The charging management server 10 is an information processing device (computer) that manages a power supply operation (charging operation) of the charging device 40. The charging management server 10 may be a PC server, a midrange server, or a mainframe server. The charging management server 10 enables the user to charge the moving body 60 by using the power supply facility 50 inside and outside the home. In the following description, a service that is provided to the user by using the charging management server 10 and enables the user to charge the moving body 60 by using the power supply facility 50 inside and outside the home may be referred to as a “charging infrastructure service”. The charging management server 10 is managed by, for example, a business operator providing the charging infrastructure service.

In order to enable the charging infrastructure service to be provided to the user, the charging management server 10 may provide the following functions (1) to (5) for the administrator of the charging infrastructure service. These functions may be executable via a web application.
(1) Administrator login
(2) Registration/deletion of an establishment that provides the power supply facility 50 (for example, a parking lot or the like)
(3) Issuance of the establishment administrator ID/initial password
(4) Search/display chargeable place
(5) Management information of the charging device 40

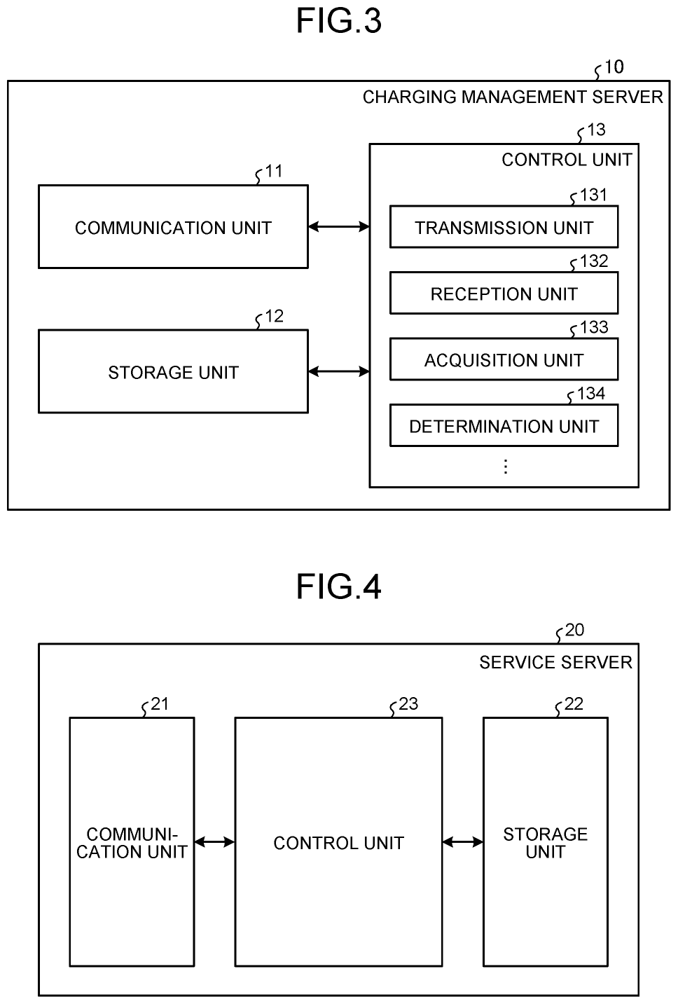

FIG. 3 is a diagram illustrating a configuration example of the charging management server 10 according to the embodiment of the present disclosure. The charging management server 10 includes a communication unit 11, a storage unit 12, and a control unit 13. Note that the configuration illustrated in FIG. 3 is a functional configuration, and the hardware configuration may be different from the functional configuration. Furthermore, the functions of the charging management server 10 may be distributed in a plurality of physically separated configurations to be implemented. For example, the charging management server 10 may include a plurality of server devices.

The communication unit 11 is a communication interface for communicating with other devices. For example, the communication unit 11 is a local area network (LAN) interface such as a network interface card (NIC). Furthermore, the communication unit 11 may be a wired interface or a wireless interface. The communication unit 11 communicates with the charging device 40 and the like under the control of the control unit 13.

The storage unit 12 is a data readable/writable storage device such as a dynamic random access memory (DRAM), a static random access memory (SRAM), a flash memory, or a hard disk. The storage unit 12 functions as a storage unit of the charging management server 10. The storage unit 12 stores, for example, various types of information for managing the charging device 40. For example, the storage unit 12 stores information on a chargeable place provided by the charging infrastructure service, management information of each of the plurality of charging devices 40 for using the charging infrastructure service, user information of the charging infrastructure service, and the like. Here, the user information may store data in which the ID information of each of the plurality of charging devices 40 and the information of the user of each of the plurality of charging devices 40 are associated with each other. Here, the information of the user may include registered address information of the user who possesses the charging device 40.

The control unit 13 is a controller that controls each unit of the charging management server 10. The control unit 13 is realized by, for example, a processor such as a central processing unit (CPU) or a micro processing unit (MPU). For example, the control unit 13 is realized by the processor executing various programs stored in the storage device inside the charging management server 10 using a random access memory (RAM) or the like as a work area. Note that the control unit 13 may be realized by an integrated circuit such as an application specific integrated circuit (ASIC) or a field programmable gate array (FPGA). Any of the CPU, the MPU, the ASIC, and the FPGA can be regarded as a controller. Note that the control unit 13 may be realized by a GPU in addition to or instead of the CPU.

The control unit 13 includes a transmission unit 131, a reception unit 132, an acquisition unit 133, and a determination unit 134. Each block (the transmission unit 131 to the determination unit 134) that configures the control unit 13 is a functional block indicating a function of the control unit 13. These functional blocks may be software blocks or hardware blocks. For example, each of the functional blocks described above may be one software module realized by software (including microprograms) or may be one circuit block on a semiconductor chip (die). Of course, each functional block may be one processor or one integrated circuit. The control unit 13 may be configured with a functional unit different from the above-described functional blocks. A configuration method of the functional block is arbitrary.

Note that the control unit 13 may be configured with a functional unit different from the above-described functional blocks. In addition, some or all of the operations of the blocks (the transmission unit 131 to the determination unit 134) that configure the control unit 13 may be performed by another device. For example, some or all of the operations of the blocks that configure the control unit 13 may be performed by a control unit 23 of the service server 20. The operation of each block that configures the control unit 13 is described below.

<2-2. Configuration of Service Server>

Next, a configuration of the service server 20 is described.

The service server 20 is an information processing device (computer) that collaborates (performs, for example, application programming interface (API) collaboration) with the charging management server 10. The service server 20 may be a PC server, a midrange server, or a mainframe server.

The service server 20 performs partial processing for managing a power supply operation (charging operation) of the charging device 40. The service server 20 may be a server managed by a business entity different from the administrator of the charging management server 10. Of course, the service server 20 may be a server managed by a business operator that manages the charging management server 10. As an example of the service server 20, a power contractor management server managed by an electric power company, a member information management server managed by a distribution system card company, and a parking lot management server managed by a parking lot management company are assumed.

FIG. 4 is a diagram illustrating a configuration example of the service server 20 according to the embodiment of the present disclosure. The service server 20 includes a communication unit 21, a storage unit 22, and the control unit 23. Note that the configuration illustrated in FIG. 4 is a functional configuration, and the hardware configuration may be different from the functional configuration. Furthermore, the functions of the charging management server 10 may be distributed in a plurality of physically separated configurations to be implemented. For example, the service server 20 may be configured with a plurality of server devices.

The communication unit 21 is a communication interface for communicating with other devices. For example, the communication unit 11 is a LAN interface such as an NIC. Furthermore, the communication unit 21 may be a wired interface or a wireless interface. The communication unit 21 communicates with the charging management server 10 and the like under the control of the control unit 23.

The storage unit 22 is a storage device capable of reading and writing data, such as a DRAM, an SRAM, a flash memory, or a hard disk. The storage unit 22 stores, for example, various types of information related to the user who uses the charging device 40. For example, the storage unit 22 stores contractor information of a power contract, member information of a distribution system card, or user information of a parking lot.

The control unit 23 is a controller that controls each unit of the service server 20. The control unit 23 is realized by, for example, a processor such as a CPU or an MPU. For example, the control unit 23 is implemented by the processor executing various programs stored in the storage device inside the service server 20 using a RAM or the like as a work area. Note that the control unit 23 may be realized by an integrated circuit such as an ASIC or an FPGA. Any of the CPU, the MPU, the ASIC, and the FPGA can be regarded as a controller. Note that the control unit 23 may be realized by a GPU in addition to or instead of the CPU.

Hereinafter, some specific examples of the service server 20 are described. Note that the service server 20 is not limited to the following example.

<2-2-1. Configuration of Power Contractor Management Server>

First, as an example of the service server 20, a power contractor management server 20A is described.

The power contractor management server 20A is an information processing device (computer) that manages contractor information of a power contract. The power contractor management server 20A is managed by, for example, an electric power company.

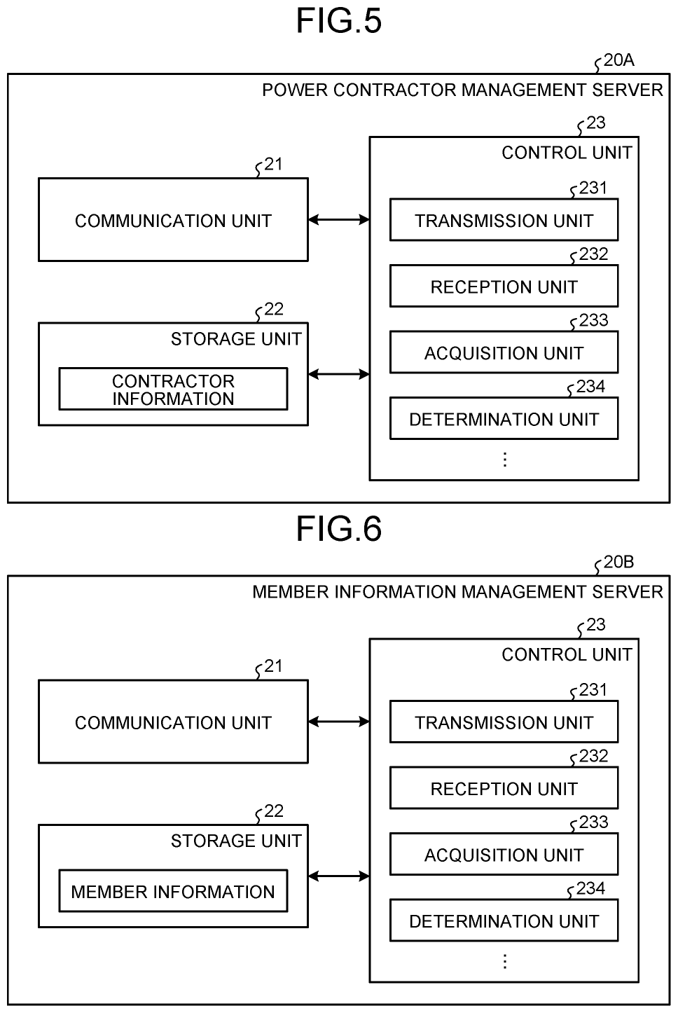

FIG. 5 is a diagram illustrating a configuration example of the power contractor management server 20A which is an example of the service server 20. The power contractor management server 20A includes the communication unit 21, the storage unit 22, and the control unit 23. The communication unit 21 is a communication interface for communicating with other devices. The storage unit 22 is a data readable/writable storage device and stores contractor information of the power contract.

The control unit 23 is a controller that controls each unit of the power contractor management server 20A. The control unit 23 includes a transmission unit 231, a reception unit 232, an acquisition unit 233, and a determination unit 234. Each block (the transmission unit 231 to the determination unit 234) that configures the control unit 23 is a functional block indicating a function of the control unit 23. These functional blocks may be software blocks or hardware blocks. For example, each of the functional blocks described above may be one software module realized by software (including microprograms) or may be one circuit block on a semiconductor chip (die). Of course, each functional block may be one processor or one integrated circuit. The control unit 23 may be configured with a functional unit different from the above-described functional blocks. A configuration method of the functional block is arbitrary.

Note that the control unit 23 may be configured with a functional unit different from the above-described functional blocks. In addition, some or all of the operations of the blocks (the transmission unit 231 to the determination unit 234) that configure the control unit 23 may be performed by another device. For example, some or all of the operations of the blocks that configure the control unit 23 may be performed by the control unit 13 of the charging management server 10. The operation of each block that configures the control unit 23 may be the same as that of each block (the transmission unit 131 to the determination unit 134) that configures the control unit 13 of the charging management server 10.

<2-2-2. Configuration of Member Information Management Server>

Next, a member information management server 20B is described as an example of the service server 20.

The member information management server 20B is an information processing device (computer) that manages member information of a predetermined service. For example, the member information management server 20B may be an information processing device that manages member information of a distribution system card or may be an information processing device that manages member information of a monthly flat-rate service. For example, the member information management server 20B may be an information processing device that manages the member information of the EV subscription service.

FIG. 6 is a diagram illustrating a configuration example of the member information management server 20B which is an example of the service server 20. The member information management server 20B includes the communication unit 21, the storage unit 22, and the control unit 23. The communication unit 21 is a communication interface for communicating with other devices. The storage unit 22 is a data readable/writable storage device and stores member information of a predetermined service.

The control unit 23 is a controller that controls each unit of the member information management server 20B. The control unit 23 includes the transmission unit 231, the reception unit 232, the acquisition unit 233, and the determination unit 234. Each block (the transmission unit 231 to the determination unit 234) that configures the control unit 23 is a functional block indicating a function of the control unit 23. These functional blocks may be software blocks or hardware blocks. For example, each of the functional blocks described above may be one software module realized by software (including microprograms) or may be one circuit block on a semiconductor chip (die). Of course, each functional block may be one processor or one integrated circuit. The control unit 23 may be configured with a functional unit different from the above-described functional blocks. A configuration method of the functional block is arbitrary.

Note that the control unit 23 may be configured with a functional unit different from the above-described functional blocks. In addition, some or all of the operations of the blocks (the transmission unit 231 to the determination unit 234) that configure the control unit 23 may be performed by another device. For example, some or all of the operations of the blocks that configure the control unit 23 may be performed by the control unit 13 of the charging management server 10. The operation of each block that configures the control unit 23 may be the same as that of each block (the transmission unit 131 to the determination unit 134) that configures the control unit 13 of the charging management server 10.

<2-2-3. Configuration of Parking Lot Management Server>

Next, a parking lot management server 20C is described as an example of the service server 20.

The parking lot management server 20C is an information processing device (computer) that manages user information of a parking lot. The parking lot management server 20C is managed by, for example, a parking lot management company that manages an hourly parking lot.

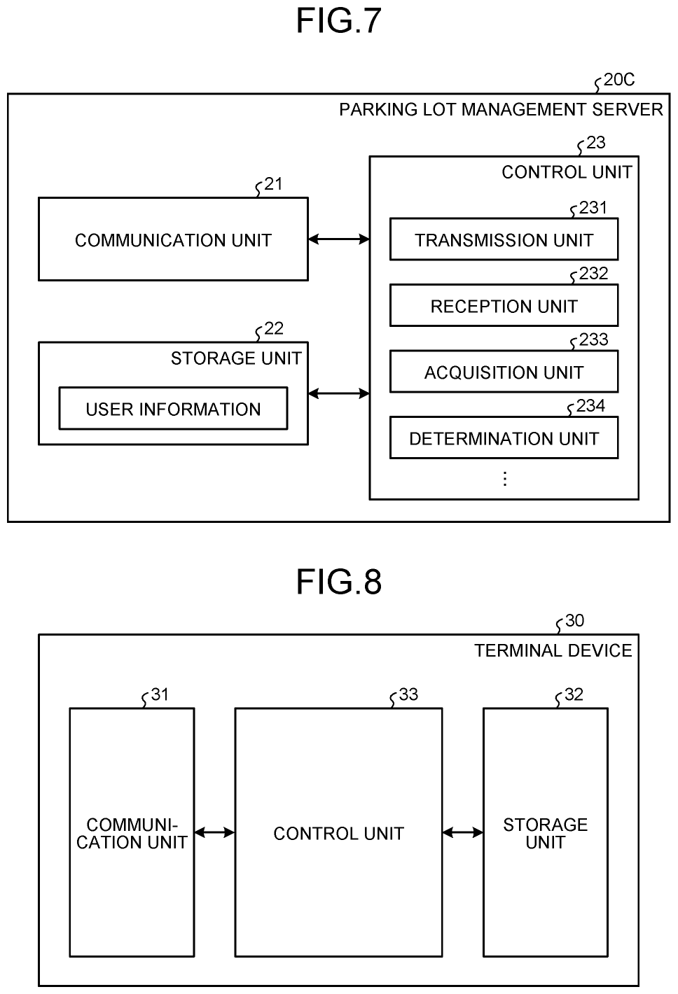

FIG. 7 is a diagram illustrating a configuration example of the parking lot management server 20C which is an example of the service server 20. The parking lot management server 20C includes the communication unit 21, the storage unit 22, and the control unit 23. The communication unit 21 is a communication interface for communicating with other devices. The storage unit 22 is a data readable/writable storage device and stores user information of the parking lot.

The control unit 23 is a controller that controls each unit of the parking lot management server 20C. The control unit 23 includes the transmission unit 231, the reception unit 232, the acquisition unit 233, and the determination unit 234. Each block (the transmission unit 231 to the determination unit 234) that configures the control unit 23 is a functional block indicating a function of the control unit 23. These functional blocks may be software blocks or hardware blocks. For example, each of the functional blocks described above may be one software module realized by software (including microprograms) or may be one circuit block on a semiconductor chip (die). Of course, each functional block may be one processor or one integrated circuit. The control unit 23 may be configured with a functional unit different from the above-described functional blocks. A configuration method of the functional block is arbitrary.

Note that the control unit 23 may be configured with a functional unit different from the above-described functional blocks. In addition, some or all of the operations of the blocks (the transmission unit 231 to the determination unit 234) that configure the control unit 23 may be performed by another device. For example, some or all of the operations of the blocks that configure the control unit 23 may be performed by the control unit 13 of the charging management server 10. The operation of each block that configures the control unit 23 may be the same as that of each block (the transmission unit 131 to the determination unit 134) that configures the control unit 13 of the charging management server 10.

<2-3. Configuration of Terminal Device>

Next, the configuration of the terminal device 30 is described.

The terminal device 30 is a communication device that communicates with the charging management server 10. For example, the terminal device 30 is a terminal possessed by a user who uses the charging device 40. The terminal device 30 exchanges various types of information related to the charging device 40 with the charging management server 10. For example, the terminal device 30 exchanges information for the user to remotely operate the charging device 40 with the charging management server 10.

The terminal device 30 is, for example, a mobile phone, a smart device (a smartphone or a tablet), a personal digital assistant (PDA), or a personal computer. Furthermore, the terminal device 30 may be an imaging device (for example, a camcorder) having a communication function or may be a moving body (for example, a motorcycle or a moving relay vehicle) on which a communication device such as a field pickup unit (FPU) is mounted. Furthermore, the terminal device 30 may be an M2M (Machine to Machine) device or an IoT (Internet of Things) device.

The terminal device 30 can perform various operations related to charging of the moving body 60. At this time, the user may install an application for the user of the moving body 60 on the terminal device 30 and perform various operations related to the charging infrastructure service. As described above, the charging infrastructure service is a service that is provided to the user by using the charging management server 10 and enables the user to charge the moving body 60 using the power supply facility 50 inside and outside the home. Here, as the operation that can be performed by the user using the terminal device 30, for example, the following (1) to (5) can be assumed.
(1) Registration of member for causing charging infrastructure service to be available
(2) Searching/viewing of chargeable place provided in charging infrastructure service
(3) Displaying of the charging status (during charging, end of charging, or the like)
(4) Displaying of use history of the charging infrastructure service
(5) Displaying of a website of the charging infrastructure service

FIG. 8 is a diagram illustrating a configuration example of the terminal device 30 according to the embodiment of the present disclosure. The terminal device 30 includes a communication unit 31, a storage unit 32, and a control unit 33. Note that the configuration illustrated in FIG. 8 is a functional configuration, and the hardware configuration may be different from the functional configuration. Furthermore, the functions of the terminal device 30 may be distributed in a plurality of physically separated configurations to be implemented.

The communication unit 31 is a communication interface for communicating with other devices. For example, the communication unit 31 is a LAN interface such as an NIC. Furthermore, the communication unit 31 may be a wired interface or a wireless interface. The communication unit 31 communicates with the charging management server 10 and the like under the control of the control unit 33.

The storage unit 32 is a storage device capable of reading and writing data, such as a DRAM, an SRAM, a flash memory, or a hard disk.

The control unit 33 is a controller that controls each unit of the terminal device 30. The control unit 33 is realized by, for example, a processor such as a CPU or an MPU. For example, the control unit 33 is implemented by the processor executing various programs stored in the storage device inside the terminal device 30 using a RAM or the like as a work area. Note that the control unit 33 may be realized by an integrated circuit such as an ASIC or an FPGA. Any of the CPU, the MPU, the ASIC, and the FPGA can be regarded as a controller. Note that the control unit 33 may be realized by a GPU in addition to or instead of the CPU.

<2-4. Configuration of Charging Device>

Next, the configuration of the charging device 40 is described.

The charging device 40 is a device that receives power from the power supply facility 50 and supplies the power to the moving body 60 and is a portable charger separate from the power supply facility.

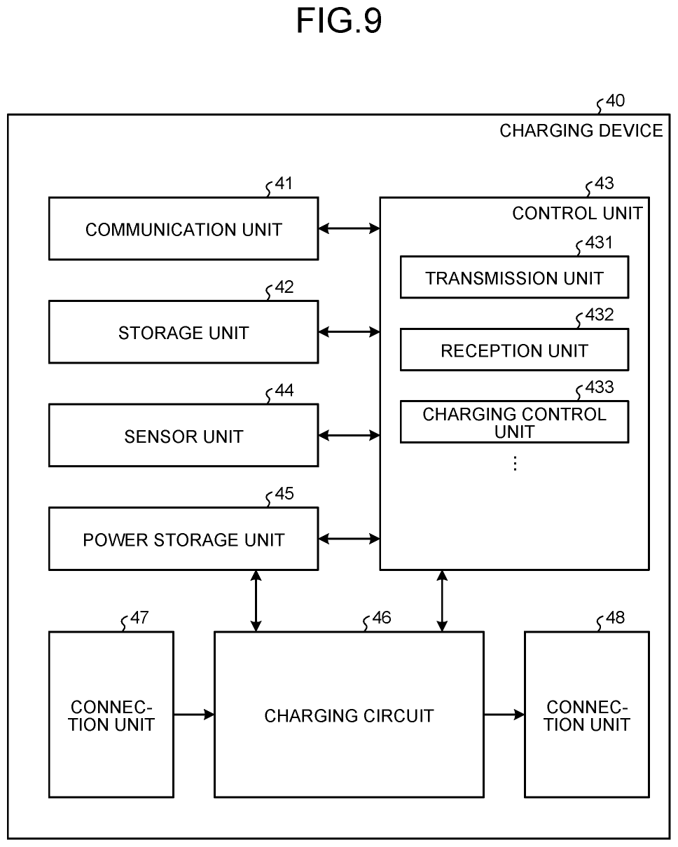

FIG. 9 is a diagram illustrating a configuration example of the charging device 40 according to the embodiment of the present disclosure. The charging device 40 includes a communication unit 41, a storage unit 42, a control unit 43, a sensor unit 44, a power storage unit 45, a charging circuit 46, a connection unit 47, and a connection unit 48. Note that the configuration illustrated in FIG. 9 is a functional configuration, and the hardware configuration may be different from the functional configuration. Furthermore, the functions of the charging device 40 may be distributed in a plurality of physically separated configurations to be implemented.

The communication unit 41 is a communication interface for communicating with other devices. For example, the communication unit 41 is a LAN interface such as an NIC. Furthermore, the communication unit 41 may be a wired interface or a wireless interface. The communication unit 41 communicates with the charging management server 10 and the like under the control of the control unit 43.

The storage unit 42 is a storage device capable of reading and writing data, such as a DRAM, an SRAM, a flash memory, or a hard disk.

The control unit 43 is a controller that controls each unit of the charging device 40. The control unit 43 is realized by, for example, a processor such as a CPU or an MPU. For example, the control unit 43 is implemented by the processor executing various programs stored in the storage device inside the charging device 40 using a RAM or the like as a work area. Note that the control unit 43 may be realized by an integrated circuit such as an ASIC or an FPGA. Any of the CPU, the MPU, the ASIC, and the FPGA can be regarded as a controller. Note that the control unit 43 may be realized by a GPU in addition to or instead of the CPU.

The control unit 43 includes a transmission unit 431, a reception unit 432, and a charging control unit 433. Each block (the transmission unit 431 to the charging control unit 433) that configures the control unit 43 is a functional block indicating a function of the control unit 43. These functional blocks may be software blocks or hardware blocks. For example, each of the functional blocks described above may be one software module realized by software (including microprograms) or may be one circuit block on a semiconductor chip (die). Of course, each functional block may be one processor or one integrated circuit. The control unit 43 may be configured with a functional unit different from the above-described functional blocks. A configuration method of the functional block is arbitrary.

Note that the control unit 43 may be configured with a functional unit different from the above-described functional blocks. In addition, some or all of the operations of the blocks (the transmission unit 431 to the charging control unit 433) that configure the control unit 43 may be performed by another device. The operation of each block that configures the control unit 13 is described below.

The sensor unit 44 is a sensor that detects the current position of the charging device 40. The sensor unit 44 is configured with, for example, a GPS sensor or an acceleration sensor. The sensor unit 44 detects the current position of the charging device 40 and outputs information indicating the current position of the charging device 40 (hereinafter, simply referred to as position information) to the control unit 43.

The power storage unit 45 is a device that stores electric power from the power supply facility 50. For example, when the user disconnects the connection with the power supply facility 50 without following a proper procedure and the power from the power supply facility 50 is interrupted, the power storage unit 45 supplies power for performing a charging end process. The power storage unit 45 may be a power storage component such as an electric double layer capacitor or an electrolytic capacitor, and a power storage unit 62 may be a secondary battery such as a lead storage battery, a lithium ion battery, a nickel-hydrogen battery, a nickel-cadmium battery, or an all-solid-state battery.

The charging circuit 46 is a circuit that outputs power for supplying power to an external device (for example, the moving body 60). The charging circuit 46 includes an AC/DC converter that converts AC power from the power supply facility 50 into DC power, a DC/DC converter that converts a voltage level, and/or various switches that turn on and off a power output to the external device. The charging circuit 46 turns on and off power supply to the external device under the control of the control unit 43.

The connection unit 47 is a connection component connectable to the power supply facility 50. For example, when the power supply facility 50 includes an AC outlet, the connection unit 47 is an AC plug that can be inserted into and removed from the AC outlet. Assuming that the power supply facility 50 includes a DC output terminal, the connection unit 47 is a DC plug that can be inserted into and removed from the DC output terminal. The connection unit 47 supplies power from the power supply facility 50 to the charging circuit 46.

The connection unit 48 is a connection component connectable to the moving body 60. For example, assuming that the moving body 60 includes an inlet conforming to a predetermined charging standard (for example, CHAdeMO), the connection unit 47 is a connector conforming to the corresponding predetermined charging standard. The connection unit 48 may be configured to enable communication (for example, controller area network (CAN) communication) between the control unit 43 of the charging device 40 and the moving body 60 connected to the charging device 40 via the connection unit 48. The connection unit 48 supplies the power generated by the charging circuit 46 to the moving body 60.

<2-5. Configuration of Power Supply Facility>

Next, the configuration of the power supply facility 50 is described.

The power supply facility 50 is a facility that supplies power (for example, a low power AC power of 3 kW or less) to the charging device 40. The power supply facility 50 is, for example, a commercial AC power supply. The power supply facility 50 may be an existing facility. For example, the power supply facility may be an AC power supply (AC outlet) installed in a general house or may be an on-road outlet installed on a road. Furthermore, the power supply facility 50 may be a facility that is newly installed for charging the moving body.

The power supplied by the power supply facility 50 is not limited to low power AC power and may be high power (for example, power greater than 3 kW). In addition, the power supplied by the power supply facility 50 is not limited to AC power and may be DC power. In addition, the power supply facility 50 may be an AC/DC power supply supplied by an entity other than an electric power company.

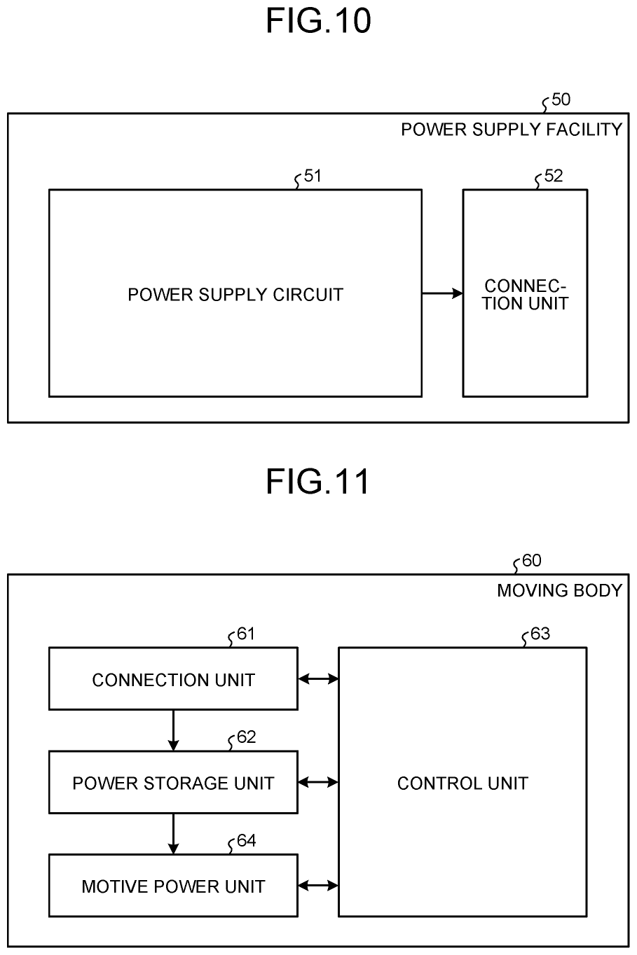

FIG. 10 is a diagram illustrating a configuration example of the power supply facility 50 according to the embodiment of the present disclosure. The power supply facility 50 includes a power supply circuit 51 and a connection unit 52. Note that the configuration illustrated in FIG. 10 is a functional configuration, and the hardware configuration may be different from the functional configuration. Furthermore, the functions of the power supply facility 50 may be distributed in a plurality of physically separated configurations to be implemented.

The power supply circuit 51 is a power conversion circuit that generates output power from input power. The power supply circuit 51 converts a voltage, a frequency, and the like of power supplied from the power generation facility via the power transmission facility and outputs the converted power to the connection unit 52. In addition, the power supply circuit 51 may convert AC power into DC power and output the DC power.

The connection unit 52 is a connection component for connecting the connection unit 47 of the charging device 40. For example, assuming that the charging device 40 includes an AC plug as the connection unit 47, the connection unit 52 is an AC outlet into which the AC plug can be inserted and removed. Assuming that the charging device 40 includes a DC plug as the connection unit 47, the connection unit 52 is a DC output terminal into which the DC plug can be inserted and removed. The connection unit 52 supplies the power generated by the power supply circuit 51 to the charging device 40.

<2-6. Configuration of Moving Body>

Next, the configuration of the moving body 60 is described.

The moving body 60 is a device to be charged by the charging device 40. Note that, in the present embodiment, the charging target of the charging device 40 is a moving body. However, as long as charging is possible, the charging target of the charging device 40 may not necessarily be a moving body.

The moving body 60 is typically an EV but may not necessarily be an EV. For example, the moving body 60 may be a chargeable hybrid vehicle (for example, a plug-in hybrid vehicle (PHV)). Furthermore, the moving body 60 may be a mobile terminal such as a smartphone, a tablet, a mobile phone, or a notebook PC.

Furthermore, the moving body 60 may be a moving body that moves on land (for example, a vehicle such as an automobile, a bicycle, a bus, a truck, a motorcycle, a train, or a linear motor car) or may be a moving body that moves under the ground (for example, in the tunnel) (for example, the subway). Furthermore, the moving body 60 may be a moving body that moves on water (for example, a ship such as a passenger ship, a cargo ship, or a hovercraft) or may be a moving body that moves under water (for example, a submarine such as a submersible boat, a submersible vessel, and an unmanned submersible). Furthermore, the moving body 60 may be a moving body that moves inside the atmosphere (for example, an aircraft such as an airplane, an airship, a helicopter, and a drone) or a moving body that moves outside the atmosphere (for example, an artificial celestial body such as an artificial satellite, a spacecraft, a space station, and a probe).

FIG. 11 is a diagram illustrating a configuration example of the moving body 60 according to the embodiment of the present disclosure. The moving body 60 includes a connection unit 61, a power storage unit 62, a control unit 63, and a motive power unit 64. Note that the configuration illustrated in FIG. 11 is a functional configuration, and the hardware configuration may be different from the functional configuration. Furthermore, the functions of the moving body 60 may be distributed in a plurality of physically separated configurations to be implemented.

The connection unit 61 is a connection component for connecting the connection unit 48 of the charging device 40. For example, assuming that the charging device 40 includes a connector conforming to a predetermined charging standard (for example, CHAdeMO) as the connection unit 48, the connection unit 61 is an inlet conforming to the corresponding predetermined charging standard. The connection unit 61 may be configured to enable communication (CAN communication) between the control unit 63 of the moving body 60 and the charging device 40 connected to the moving body 60 via the connection unit 61. The connection unit 61 supplies power supplied from the charging device 40 to the power storage unit 62.

The power storage unit 62 is a device that stores power supplied from the charging device 40 via the connection unit 61. For example, the power storage unit 62 is a secondary battery such as a lead storage battery, a lithium ion battery, a nickel-hydrogen battery, a nickel-cadmium battery, or an all-solid-state battery.

The control unit 63 is a controller that controls each unit of the moving body 60. The moving body 60 is realized by, for example, a processor such as a CPU or an MPU. For example, the moving body 60 is implemented by the processor executing various programs stored in the storage device inside the moving body 60 using a RAM or the like as a work area. Note that the moving body 60 may be realized by an integrated circuit such as an ASIC or an FPGA. Any of the CPU, the MPU, the ASIC, and the FPGA can be regarded as a controller. Note that the moving body 60 may be realized by a GPU in addition to or instead of the CPU.

The motive power unit 64 is motive power operated by power supplied from the power storage unit 62. For example, the motive power unit 64 is a motor that drives various mechanisms included in the moving body 60.

### 3. OPERATION OF CHARGING SYSTEM

The configuration of the charging system 1 is described above. Hereinafter, the operation of the charging system 1 is described. The operation of the charging system 1 is described in the following order.

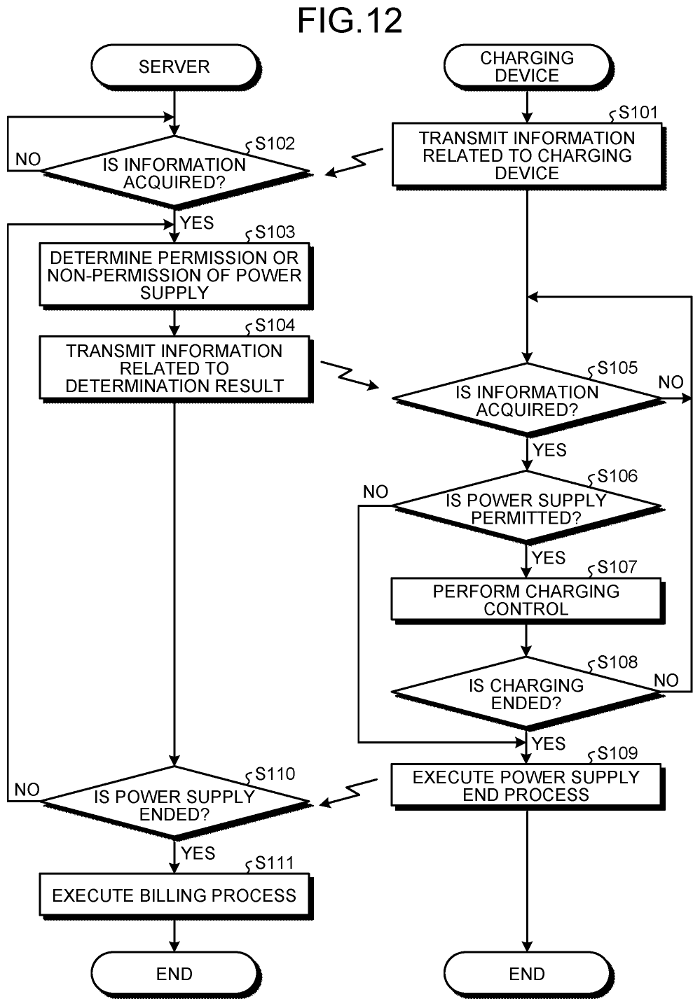

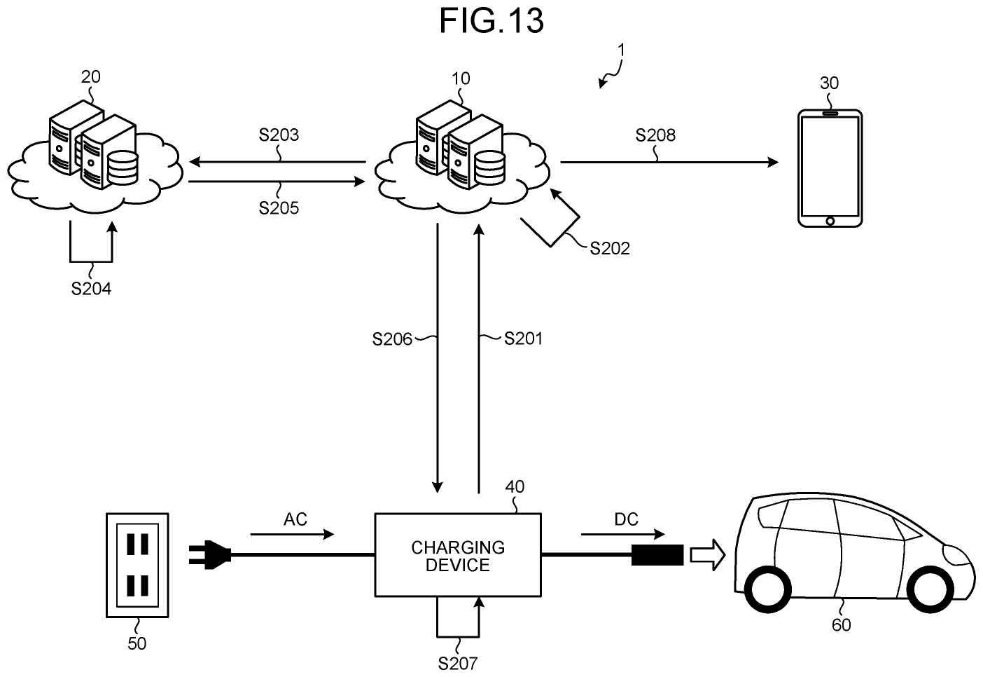

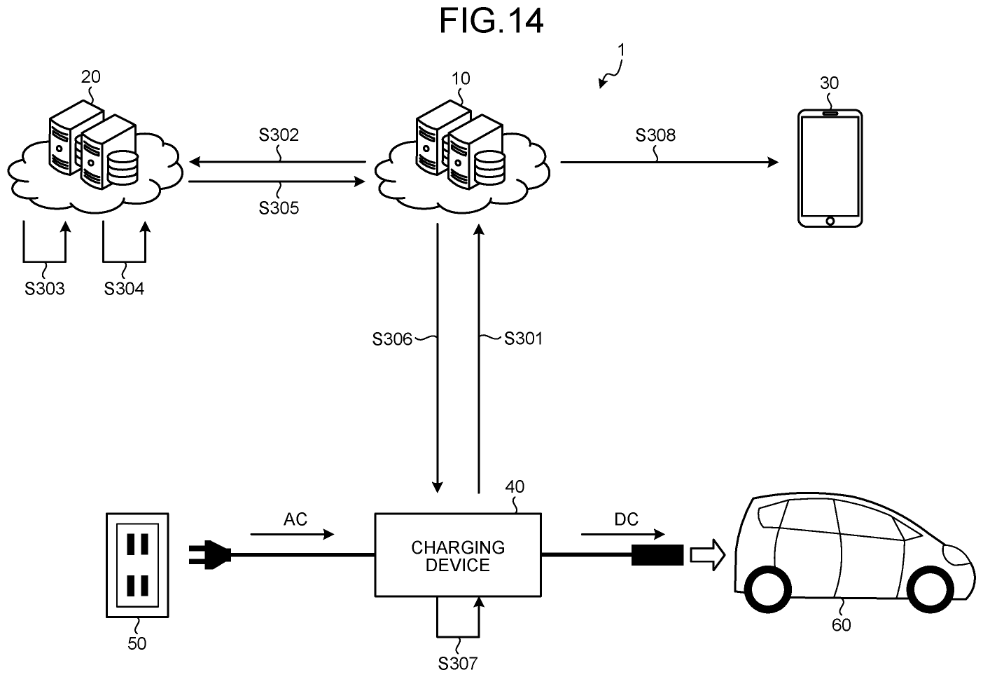

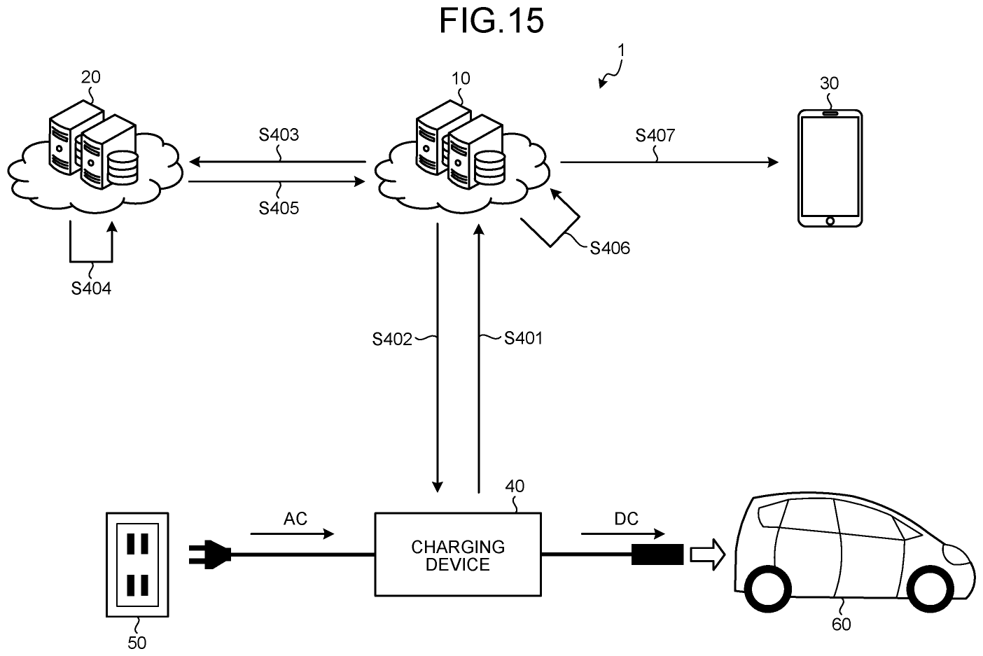

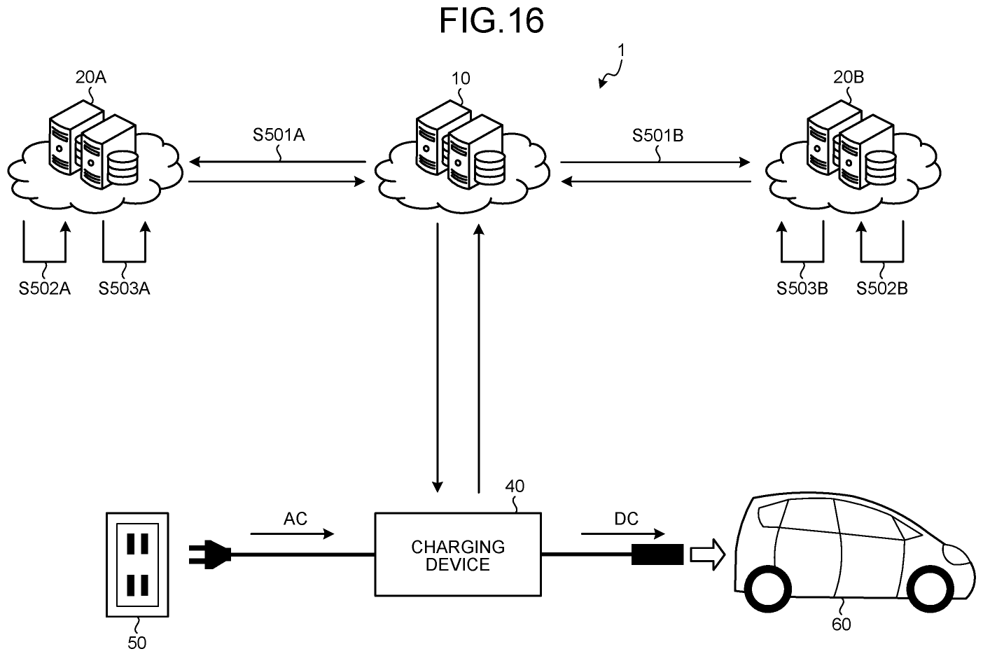

First, a charging management process as a basic form of the operation of the charging system 1 is described with reference to FIG. 12. Thereafter, operation examples of the charging system 1 at the start of charging (FIG. 13), during charging (FIG. 14), at the end of charging (FIG. 15), and at the time of billing to the user (FIG. 16) are described.

<3-1. Charging Management Process>

First, the charging management process as the basic form of the operation of the charging system 1 is described. FIG. 12 is a flowchart illustrating the charging management process according to the present embodiment.

In the following description, it is assumed that the device that determines power supply availability is the charging management server 10, but the device that determines power supply availability is not limited to the charging management server 10. For example, the device that determines power supply availability may be the service server 20 such as the power contractor management server 20A, the member information management server 20B, and the parking lot management server 20C.

The description of “the charging management server 10” described below can be replaced with “the service server 20”, “the power contractor management server 20A”, “the member information management server 20B”, or “the parking lot management server 20C” as appropriate. In this case, the descriptions indicating the control unit 13 of the charging management server 10 and each block that configures the control unit 13 (for example, “the transmission unit 131” to “the determination unit 134”) are appropriately replaced with the descriptions indicating the control unit 23 of the service server 20 and each block that configures the control unit 23 (for example, “the transmission unit 231” to “the determination unit 234”).

When the charging management server 10 is replaced with the service server 20, the service server 20 may communicate with the charging device 40 via the charging management server 10.

Hereinafter, the charging management process is described with reference to the flowchart of FIG. 12. The following flowchart is executed, for example, when the charging device 40 is powered on. For example, the process is executed when the charging device 40 is connected to the power supply facility 50 and the supply of the AC power is started.

When the charging device 40 is powered on, the transmission unit 431 of the charging device 40 transmits information related to the charging device to the charging management server 10 (Step S101). As the information related to the charging device, for example, the following (1) to (4) can be assumed.
(1) Position information of the charging device 40
(2) Use time or power consumption amount of charging device 40
(3) Maintenance status of the charging device 40 or device connected to the charging device 40 (the power supply facility 50 or the moving body 60)
(4) Abnormality detection information of the charging device 40 or a device connected to the charging device 40 (for example, occurrence of failure or a failure part)

The information of the device connected to the charging device 40 may be acquired by the charging device 40 from the corresponding device (the power supply facility 50 or the moving body 60) by, for example, CAN communication or wired communication using a power line (for example, PLC).

In the following description, it is assumed that the information related to the charging device includes at least position information of the charging device 40. At this time, the position information of the charging device 40 may be GPS information acquired by a global positioning system (GPS) sensor.

The process proceeds to the process on the charging management server 10 side, and the reception unit 132 of the charging management server 10 receives information from the charging device 40. Then, the acquisition unit 133 of the charging management server 10 determines whether the information related to the charging device is included in the information received from the charging device 40 (Step S102). For example, when the information related to the charging device is the position information of the charging device 40, the acquisition unit 133 determines whether the position information of the charging device 40 is included in the information received by the reception unit 132. When the information related to the charging device is not acquired (Step S102: No), the reception unit 132 and the acquisition unit 133 repeat Step S102.

When the information related to the charging device is acquired (Step S102: Yes), the acquisition unit 133 acquires the information related to the charging device from the received information. For example, the acquisition unit 133 acquires the position information of the charging device 40. Then, the determination unit 134 of the charging management server 10 determines permission or non-permission of power supply to the charging device 40 based on the information related to the charging device (Step S103). At this time, the determination unit 134 also determines permission or non-permission of continuation of power supply in addition to the determination on permission or non-permission of the start of power supply.

As a determination method, various methods can be adopted. For example, the determination unit 134 may determine permission or non-permission of power supply based on the position information of the charging device 40. Determination of permission or non-permission of power supply is described in detail below. In the following description, determination on permission or non-permission of power supply may be referred to as determination on power supply availability.

Subsequently, the transmission unit 131 of the charging management server 10 transmits information related to the determination result to the charging device 40 (Step S104). As described above, the information related to the determination result may be control information for controlling the charging device 40 or may be notification information simply notifying the charging device 40 of the determination result. As examples of the notification information, power supply permission information and power supply prohibition information are assumed. If the charging device 40 operates according to the notification, the notification information can be regarded as the control information.

The process proceeds to the process on the charging device 40 side, and the reception unit 432 of the charging device 40 receives information from the charging management server 10. Then, the reception unit 432 of the charging device 40 determines whether the information related to the determination result is included in the information received from the charging management server 10 (Step S105). When the information related to the determination result is not acquired (Step S105: No), the reception unit 432 repeats Step S105.

When the information related to the determination result is acquired (Step S105: Yes), the charging control unit 433 of the charging device 40 controls on/off of power supply to the moving body 60 based on the information related to the determination result. Specifically, the charging control unit 433 determines whether power supply is permitted based on the information related to the determination result (Step S106). If the power supply is not permitted (Step S106: No), the charging control unit 433 advances the process to Step S109. If the power supply is permitted (Step S106: Yes), the charging control unit 433 controls the charging circuit 46 to perform power supply to the moving body 60 (Step S107).

Subsequently, the charging control unit 433 determines whether the charging is ended (Step S108). For example, the charging control unit 433 determines whether the moving body 60 is fully charged or is charged with a predetermined amount of power. If charging is not ended (Step S108: No), the charging control unit 433 returns the process to Step S105.

If charging is ended (Step S108: Yes), the charging control unit 433 executes a power supply end process (Step S109). For example, the charging control unit 433 stops power output from the charging circuit 46 to the connection unit 48 and releases lock between the connection unit 48 of the charging device 40 (for example, a connector conforming to CHAdeMO) and the connection unit 61 of the moving body 60 (for example, an inlet conforming to CHAdeMO). Then, the charging control unit 433 notifies the charging management server 10 of the end of the power supply. Note that this notification may include information on the power consumption amount of the charging device 40. When the notification to the charging management server 10 is completed, the charging device 40 ends the charging management process.

The process proceeds to the process on the charging management server 10 side, and the control unit 13 of the charging management server 10 determines whether the power supply of the charging device 40 is ended (Step S110). For example, the control unit 13 determines whether the information indicating the end of the power supply is included in the information received from the charging device 40. If the power supply is not ended (Step S110: No), the control unit 13 returns the process to Step S103.

If the charging is ended (Step S110: Yes), the control unit 13 of the charging management server 10 executes a billing process for the user (Step S111). For example, the control unit 13 of the charging management server 10 acquires information of the power consumption amount from the charging device 40 and also executes a process of billing the electricity rate to the user based on the power consumption amount. If the billing process is completed, the charging management server 10 ends the charging management process.

<3-2. Determination on Power Supply Availability>

Although the charging management process, which is a basic form of the operation of the charging system 1, is described above, the determination of power supply availability (Step S103 described above) is described in detail before describing an operation example at the start of charging.

The determination unit 134 of the charging management server 10 determines permission or non-permission of power supply of the charging device 40 based on the information related to the charging device. For example, the determination unit 134 determines the power supply availability of the charging device 40 based on the position information of the charging device 40. As described above, the determination unit 134 also determines permission or non-permission of continuation of power supply in addition to the determination on permission or non-permission of the start of power supply. Hereinafter, the determination on power supply availability is described separately for the determination on permission or non-permission of the start of the power supply (may be referred to as “power supply start determination”) and the determination on permission or non-permission of the continuation of the power supply (may be referred to as “power supply continuation determination”).

<3-2-1. Power Supply Start Determination>

As described above, the determination unit 134 of the charging management server 10 determines permission or non-permission of a start of power supply of the charging device 40 based on the information related to the charging device. At this time, the determination unit 134 may determine whether the power supply can be started based on the position information of the charging device 40. Hereinafter, the power supply start determination is described in detail.

(A) Charging at Registered Position

For example, the acquisition unit 133 acquires registered position information related to a user associated with the charging device 40 (hereinafter, simply referred to as a user) in addition to the position information of the charging device 40. This registered position information may be registered address information on the power contract of the user. When the registered position information is the registered address information on the power contract, the acquisition unit 133 may acquire the corresponding information from the power contractor management server 20A.

Then, the determination unit 134 determines power supply availability based on the position information of the charging device 40 and the registered position information. For example, when it is determined that the charging device 40 is positioned in a place indicated by the registered position information (for example, the address on the power contract of the user), it is determined that the user intends to charge the moving body 60 by using the power supply facility 50 at home. In this case, the determination unit 134 determines to permit power supply to the charging device 40.

(B) Charging Outside Registered Position

Meanwhile, when it is determined that the charging device 40 is not positioned in the place indicated by the registered position information (for example, the address on the power contract of the user), it is determined that the user intends to charge the moving body 60 by using the power supply facility 50 outside the home. In this case, the determination unit 134 determines whether the power supply of the charging device 40 can be started according to a predetermined condition.

Various conditions can be adopted as the predetermined conditions. For example, as the predetermined condition, the following conditions (B1) to (B9) are assumed. Note that the condition used for determination by the determination unit 134 is not limited to one. The determination unit 134 determines whether power supply can be started based on at least one of a plurality of conditions including the following conditions (B1) to (B9).

(B1) a Condition Related to a Place where a Charging Device is Positioned

The predetermined condition may include a condition related to a place where the charging device 40 is positioned. For example, the determination unit 134 may determine power supply availability based on whether the charging device 40 is positioned at a predetermined place. For example, the acquisition unit 133 acquires position information of one or a plurality of the power supply facilities 50 in which the charging management server 10 is opened to the user for charging, in addition to the position information of the charging device 40. Then, the determination unit 134 determines power supply availability of the charging device 40 based on the position information of the charging device 40 and the position information of the power supply facility 50. For example, when the position of the charging device 40 is positioned within a predetermined range of the power supply facility 50 managed by the charging management server 10, it is assumed that the user intends to use the power supply facility 50 opened to the user, and it is determined to permit the start of the power supply of the charging device 40. As a result, it is possible to prevent the user from erroneously using the power supply facility 50 that is not opened to the user.

(B2) a Condition Set by an Administrator of a Facility

The predetermined condition may include a condition determined by an administrator who manages the power supply facility 50 to be used by the user (hereinafter, simply referred to as an administrator) (hereinafter, referred to as a first condition). Here, the first condition may be that, for example, by allowing the user to use the power supply facility 50, the power consumption amount of the administrator for a predetermined period of time does not exceed the power amount set by the administrator. The determination unit 134 determines whether the current state satisfies the first condition and determines to permit the start of the power supply of the charging device 40 when the current state satisfies the first condition.

(B3) a Condition Set by a User of a Charging Device

The predetermined condition may include a condition set by the user associated with 40 (hereinafter, referred to as a second condition). Here, the second condition may be that, for example, by using the power supply facility 50, the power consumption amount of the user for a predetermined period of time does not exceed the power amount set by the user. The determination unit 134 determines whether the current state satisfies the second condition and determines to permit the start of the power supply of the charging device 40 when the current state satisfies the second condition. This enables charging within a range intended by the user.

(B4) a Condition Related to a Contract of a User

The predetermined condition may include a condition related to a contract for using the power supply facility (hereinafter, referred to as a third condition). Here, the third condition may be, for example, whether the contract of the user related to the use of the power supply facility is a contract that allows the use of the power supply facility 50 of a parking lot where the charging device 40 is currently positioned. At this time, the acquisition unit 133 may acquire the contract information of the user related to the use of the power supply facility from, for example, the parking lot management server 20C. Furthermore, the third condition may be whether information related to the contract status of the user, such as a use history and a payment record, satisfies a predetermined criterion. The determination unit 134 determines whether the contract of the user satisfies the third condition and determines to permit the start of the power supply of the charging device 40 when the contract satisfies the third condition.

(B5) a Condition Related to Surplus Power

The predetermined condition may include a condition related to surplus power of an area where the charging device 40 is positioned. For example, the acquisition unit 133 acquires information on excess or deficiency of surplus power of the total power supply amount with respect to the supply limit value in the entire jurisdiction area of the electric power company. Then, when the surplus power of the jurisdiction area of the electric power company where the charging device 40 is positioned falls below a predetermined threshold value, the determination unit 134 may determine not to permit the start of power supply of the charging device 40. As a result, charging of the moving body 60 at the time when the power demand is at the peak (for example, daytime in summer) is suppressed, and thus the power demand can be leveled.

(B6) A Condition Related to Pre-Securing of Right to Use Power by an Administrator

The predetermined condition may include a condition related to pre-securing of the right to use power by the administrator. For example, the acquisition unit 133 acquires history information indicating that the administrator predicts the visit of the user and secures the right to use power necessary for charging in the future transaction or the like in advance. Alternatively, the acquisition unit 133 acquires history information indicating that the administrator secures the right to use power necessary for charging in a future transaction or the like in advance, at the same time as the completion of the parking lot reservation by the user. Then, when the right to use power is secured in advance by the administrator, the determination unit 134 determines to permit the start of power supply of the charging device 40. This enables charging within a range intended by the administrator.

(B7) A Condition Related to Pre-Reservation of Power Use by an Administrator

The predetermined condition may include a condition related to pre-reservation of power use by the administrator. For example, the acquisition unit 133 acquires history information indicating that the administrator has pre-reserved the power of the power generation facility in the establishment in which the power supply facility 50 is placed at the same time as receiving the parking lot reservation from the user. Here, the history information may be reservation history information of a power generation amount and a use time of renewable energy (for example, electric power generated by the solar panel). The history information may be power amount reservation information of a power storage system such as an energy storage system (ESS). Then, when the use of power is pre-reserved by the administrator, the determination unit 134 determines to permit the start of power supply of the charging device 40. This enables charging within a range intended by the administrator.

(B8) A Condition Related to Pre-Securing of Right to Use Power by a User

The predetermined condition may include a condition related to pre-securing of the right to use power by the user. For example, the acquisition unit 133 acquires history information indicating that the user predicts his/her schedule and secures the right to use power at the time of charging in advance by himself/herself in a future transaction or the like. Then, when the right to use power is secured in advance by the user, the determination unit 134 determines to permit the start of power supply of the charging device 40. This enables charging within a range intended by the user.

(B9) A Condition Related to Pre-Reservation of Power Use by a User

The predetermined condition may include a condition related to pre-reservation of power use by the user. For example, when the user reserves a parking lot of an establishment, the acquisition unit 133 acquires history information indicating that the user has simultaneously reserved a parking place, time, and power consumption amount. Then, when the use of power is pre-reserved by the user, the determination unit 134 determines to permit the start of power supply to the charging device 40. This enables charging within a range intended by the user.

<3-2-2. Power Supply Continuation Determination>

As described above, the determination unit 134 of the charging management server 10 performs the power supply continuation determination in addition to the power supply start determination. The determination unit 134 determines whether power supply can be continued according to a predetermined condition.

Various conditions can be adopted as the predetermined conditions. For example, as the predetermined condition, the following conditions (C1) to (C8) are assumed. Note that the condition used for determination by the determination unit 134 is not limited to one. The determination unit 134 determines whether power supply can be continued based on at least one of a plurality of conditions including the following conditions (C1) to (C8).

(C1) a Condition Related to Surplus Power

The predetermined condition may include a condition related to surplus power of an area where the charging device 40 is positioned. For example, the acquisition unit 133 acquires information on excess or deficiency of surplus power of the total power supply amount with respect to the supply limit value in the entire jurisdiction area of the electric power company. Then, when the surplus power of the jurisdiction area of the electric power company where the charging device 40 is positioned falls below a predetermined threshold value, the determination unit 134 may determine not to permit power supply of the charging device 40. As a result, charging of the moving body 60 at the time when the power demand is at the peak (for example, daytime in summer) is suppressed, and thus the power demand can be leveled.

(C2) Conditions Related to Power to be Supplied

The predetermined condition may include a condition related to power to be supplied of the power generation facility. For example, the acquisition unit 133 acquires information indicating that the power to be supplied of the power generation facility in the charging establishment is strained. For example, the acquisition unit 133 acquires imbalance detection information of the generated power amount and the power consumption amount of the renewable energy (for example, electric power generated by a solar panel). Alternatively, the acquisition unit 133 acquires remaining power amount information of a power storage system such as an energy storage system. Then, when the supply power of the power generation facility is strained (for example, when the imbalance is detected or when the remaining power amount falls below the predetermined threshold value), the determination unit 134 may determine not to permit the power supply continuation of the charging device 40.

(C3) a Condition Related to Power Consumption Amount

The predetermined condition may include a condition related to the power consumption amount of the charging device 40. For example, as the information related to the charging device, the acquisition unit 133 acquires information indicating the power consumption amount of the charging device 40 from the charging device 40. Then, when the power consumption amount reaches a predetermined power amount, the determination unit 134 determines not to permit the power supply continuation of the charging device 40. This enables charging within a range intended by the user.

(C4) a Condition Related to Pre-Reservation of Power Use by a User

The predetermined condition may include a condition related to pre-reservation of power use by the user. For example, the acquisition unit 133 acquires reservation information of the power consumption amount from the user. The power amount indicated by the reservation information (hereinafter, referred to as a reserved power amount) corresponds to the predetermined power amount at (C3). Then, when the power consumption amount reaches a reserved power amount, the determination unit 134 determines not to permit the power supply continuation of the charging device 40. This enables charging within a range intended by the user.

(C5) a Condition Related to Occurrence of an Abnormality

The predetermined condition may include a condition related to abnormality detection of the device related to charging. For example, the acquisition unit 133 acquires abnormality detection information indicating that an abnormality has occurred in the charging device 40 during charging of the moving body 60. Alternatively, the acquisition unit 133 acquires abnormality detection information indicating that an abnormality occurs in any one of a plurality of devices related to charging (for example, the charging device 40, the power supply facility 50, and the moving body 60) while the moving body 60 is being charged. Then, when an abnormality occurs in the charging device 40 or when an abnormality occurs in any one of the plurality of devices, the determination unit 134 determines not to permit power supply continuation of the charging device 40. This enables the user to safely perform charging.

(C6) a Condition Related to a System Failure

The predetermined condition may include a condition related to a system failure. For example, the acquisition unit 133 acquires notification information indicating that a system failure has occurred in one or a plurality of servers related to charging management (for example, the charging management server 10 or the service server 20). Then, when an abnormality is detected in one or any of a plurality of servers, the determination unit 134 determines not to permit power supply continuation of the charging device 40. As a result, it is possible to suppress an abnormality in the process related to charging due to a system failure.

(C7) a Condition Related to a Remote Operation of a User

The predetermined condition may include a condition related to a remote operation of the user. For example, the acquisition unit 133 acquires information indicating that a charging stop request is issued from the terminal device 30 operated by the user. Then, when the charging stop is requested, the determination unit 134 determines not to permit the power supply continuation of the charging device 40. This enables charging as intended by the user.

(C8) a Condition Related to a Direct Operation of a User

The predetermined condition may include a condition related to a direct operation of the user. For example, the acquisition unit 133 acquires information indicating that a charging stop request is issued from the charging device 40 by a direct operation of the user, such as an operation of the charging device 40 in a predetermined procedure by the user. Note that the direct operation by the user may include an operation of disconnecting the connection unit 47 (for example, an AC plug) of the charging device 40 from the connection unit 52 (for example, an AC outlet) of the power supply facility 50 by the user. Then, when the charging stop is requested, the determination unit 134 determines not to permit the power supply continuation of the charging device 40. This enables charging as intended by the user.

<3-3. Operation Example at Start of Charging>

The determination of power supply availability is described above. Hereinafter, the operation of the charging system 1 at the start of charging is described.

FIG. 13 is a diagram illustrating an example of an operation of the charging system 1 at the start of charging. In the example of FIG. 13, the charging management server 10 and the service server 20 collaborate to determine whether power supply can be started. The service server 20 is, for example, a remote operation server such as the power contractor management server 20A. Hereinafter, the operation of the charging system 1 at the start of charging is described with reference to FIG. 13.

When connected to the power supply facility 50 and/or the moving body 60, the charging device 40 transmits information related to the charging device to the charging management server 10 (Step S201). In the following description, it is assumed that the information related to the charging device includes at least ID information of the charging device 40 and position information of the charging device 40.

The charging management server 10 acquires the registered position information of the user associated with the ID information of the charging device 40. The registered position information is, for example, address information on the power contract of the user. Then, the charging management server 10 determines whether the registered position information of the user matches the position information of the charging device 40 (Step S202). When the registered position information of the user matches the position information of the charging device 40, the charging management server 10 transmits a determination result indicating that the start of power supply is permitted to the charging device 40.

Meanwhile, when the registered position information of the user does not match the position information of the charging device 40, the charging management server 10 transmits information related to the charging device (ID information of charging device 40 and position information of charging device 40) to the service server 20, together with the power supply permission request (Step S203).

When receiving the power supply permission request and the information related to the charging device, the service server 20 determines whether the power supply of the charging device 40 can be started according to a predetermined condition (Step S204). For example, the service server 20 determines whether power supply can be started based on history information of the user corresponding to the ID information of the charging device 40 (for example, power contractor information). Then, the service server 20 notifies the charging management server 10 of the determination result as to whether power supply can be started (Step S205).

When receiving the determination result as to whether power supply can be started from the service server 20, the charging management server 10 transmits the received determination result to the charging device 40 (Step S206).

When receiving the determination result that the start of power supply is permitted from the charging management server 10, the charging device 40 starts power supply to the moving body 60 (Step S207). At this time, when starting power supply to the moving body 60, the charging device 40 may notify the charging management server 10 of the start of power supply. When receiving the determination result that the start of power supply is not permitted, the charging device 40 ends the charging control without starting the power supply to the moving body 60.

When the charging device 40 starts power supply to the moving body 60, the charging management server 10 notifies the terminal device 30 operated by the user of a message indicating that charging is being performed (Step S208). At this time. The charging management server 10 may determine whether the charging device 40 starts power supply based on the notification of power supply start from the charging device 40.

<3-4. Operation Example During Charging>

Next, the operation of the charging system 1 during charging is described.

FIG. 14 is a diagram illustrating an example of an operation of the charging system 1 during charging. In the example of FIG. 14, not the charging management server 10 but the service server 20 determines whether power supply can be continued. The service server 20 is, for example, a remote operation server such as the power contractor management server 20A. Hereinafter, the operation of the charging system 1 during charging is described with reference to FIG. 14.

After starting power supply to the moving body 60, the charging device 40 periodically transmits information related to the charging device to the charging management server 10 (Step S301). In the following description, it is assumed that the information related to the charging device includes at least ID information of the charging device 40 and position information of the charging device 40.

When receiving the information related to the charging device, the charging management server 10 transmits the information related to the charging device to the service server 20 (Step S302).

When receiving the information related to the charging device, the service server 20 determines whether the power supply of the charging device 40 can be continued according to a predetermined condition (Steps S303 and S304). For example, it is assumed that the service server 20 is the power contractor management server 20A managed by the electric power company. In this case, the service server 20 constantly monitors the total supply power amount and the power supply limit value of the entire jurisdiction area of the electric power company and determines to permit the power supply continuation of the charging device 40, when it is determined that surplus power is sufficient (Step S303).

Meanwhile, when it is determined that the surplus power is insufficient, the service server 20 divides the plurality of charging devices 40 into a group of charging devices that are permitted to continue power supply (hereinafter, referred to as a permitted group) and a group of charging devices that are not permitted to continue power supply (hereinafter, referred to as a non-permitted group) with reference to the usage record of the power contractor and the like, determines to permit the power supply continuation of the charging device 40 when the charging device 40 to be determined belongs to the permitted group, and determines to not permit the power supply continuation of the charging device 40 when the charging device 40 to be determined belongs to the non-permitted group (Step S304).

Then, the service server 20 notifies the charging management server 10 of the determination result as to whether the power supply can be continued (Step S305).

When receiving the determination result as to whether the power supply can be continued from the service server 20, the charging management server 10 transmits the received determination result to the charging device 40 (Step S306).

When receiving the determination result indicating that the continuation of power supply is not permitted from the charging management server 10, the charging device 40 stops power supply to the moving body 60 (Step S307). At this time, when the power supply to the moving body 60 is stopped, the charging device 40 may notify the charging management server 10 that the power supply is stopped. Note that, when receiving the determination result indicating that the start of the power supply is permitted, the charging device 40 continues the power supply to the moving body 60.

When the charging device 40 stops power supply to the moving body 60, the charging management server 10 notifies the terminal device 30 operated by the user of a message indicating that charging is stopped (Step S308). At this time, the charging management server 10 may determine whether the charging device 40 stops power supply based on a notification of power supply start from the charging device 40.

<3-5. Operation Example at End of Charging>

Next, the operation of the charging system 1 at the end of charging is described.

FIG. 15 is a diagram illustrating an example of the operation of the charging system 1 during charging.

Hereinafter, the operation of the charging system 1 at the end of charging is described with reference to FIG. 15.

The charging device 40 determines whether charging (charging) of the moving body 60 has ended. For example, the charging device 40 determines whether the moving body 60 is fully charged. Note that the charging device 40 may end charging (power supply) by a user operation.

Note that the user can end the charging operation (power supply operation) of the charging device 40 by, for example, any of the following procedures (1) to (2).
(1) A user removes the connection unit 47 (for example, an AC plug) of the charging device 40 from the connection unit 52 (for example, an AC outlet) of the power supply facility 50.
(2) The user notifies the charging device 40 of a charging stop request from the terminal device 30 via the charging management system.

After completion of the power supply, the charging device 40 notifies the charging management server 10 of the power consumption amount and the charging completion information in addition to the information related to the charging device (for example, ID information of the charging device 40 and position information of the charging device 40) (Step S401). At this time, the charging management server 10 may notify the charging device 40 of a normal reception completion flag of the charging completion information (Step S402).

When receiving the notification, the charging management server 10 notifies the service server 20 of the ID information of the charging device 40 and a power supply permission cancellation request (Step S403).

When receiving the notification, the service server 20 executes a process of canceling the permission of power supply to the charging device 40 (Step S404). Thereafter, the service server 20 notifies the charging management server 10 of power supply stop information to the charging device 40 (Step S405).

The charging management server 10 stops permission of power supply to the charging device 40 and stores status information of power supply stop (Step S406). When the storage of the status information is completed, the charging management server 10 notifies the terminal device 30 operated by the user of a message indicating that charging is ended (Step S407).

<3-6. Operation Example at Time of Billing to User>

Next, an operation of the charging system 1 at the time of billing to the user is described.

FIG. 16 is a diagram illustrating an example of an operation of the charging system 1 at the time of billing to a user. In the example of FIG. 16, an example in which the charging management server 10 performs billing to the user in collaboration with the power contractor management server 20A and an example in which the charging management server 10 performs billing to the user in collaboration with the member information management server 20B are illustrated. The power contractor management server 20A is, for example, a server with which an electric power company manages power contractor information. In addition, the member information management server 20B is, for example, a server with which a company that provides a monthly flat-rate service manages member information of the service. Hereinafter, the operation of the charging system 1 at the time of billing to the user is described with reference to FIG. 16.

(A) in Case of Collaboration with the Power Contractor Management Server 20A

The charging management server 10 transmits the ID information of the charging device 40 and the information of the power consumption amount of the charging device 40 to the power contractor management server 20A (Step S501A). The power contractor management server 20A constantly stocks information on the use time and the power consumption amount of the power supply facility 50 of the user associated with the ID information of the charging device 40. At the time of billing the user, the power contractor management server 20A adds the power consumption amount at the time of charging and the power consumption amount at the contract address, and calculates the electricity rate according to the setting of the basic rate (Step S502A). Then, the power contractor management server 20A collectively bills the EV user for the calculated electricity rate (Step S503A).

(B) In Case of Collaboration with the Member Information Management Server 20B

The charging management server 10 transmits the ID information of the charging device 40 and the information on the power consumption amount of the charging device 40 to the member information management server 20B (Step S501B). The power contractor management server 20A constantly stocks the electricity rate information calculated from the power consumption amount of the user associated with the ID information of the charging device 40. At the time of billing the user, the member information management server 20B adds the electricity rate for charging and the usage fee of the monthly flat-rate service to confirm a billing amount (Step S502B). Then, the member information management server 20B collectively charges the confirmed usage rate to the EV user (Step S503B).

### 4. CHARGING CONTROL OPERATION OF CHARGING DEVICE

The operation of the charging system 1 is described above. Hereinafter, the charging control operation of the charging device 40 is described in detail.

<4-1. First Charging Control Process>

First, the first charging control process is described.

Currently, the CHAdeMO system is known as a charging standard for EV. The current CHAdeMO system has a specification assuming an output power of about 10 kW or more and does not assume DC power supply from an AC outlet of about 3 kW or less to the EV via an AC plug and a charger.

In the CHAdeMO system, when the user tries to remove the connector conforming to CHAdeMO from the inlet of the EV during the EV charging, the user cannot remove the connector from the inlet due to the function of the locking mechanism of the connector. This is a safety measure for preventing an abnormal accident from occurring due to high-output power used for power supply of the EV.

However, this lock mechanism causes a problem when the charging device is improved so as to be able to handle output power of 3 kW or less. For example, it is assumed that the user removes the AC plug of the charging device from the AC outlet during EV charging. In this case, the lock mechanism of the connector remains locked, and the user cannot remove the connector conforming to CHAdeMO from the inlet of the EV.

Therefore, in the first charging control process, by mounting the power supply function (the power storage unit 45) on the charging device 40, the charging control unit 433 of the charging device 40 can perform the power supply stop process by using the power stored in the power storage unit 45 even when the connection with the power supply facility 50 is disconnected before the power supply stop process. As a result, it is possible to safely perform charging control on the moving body 60 with insertion and removal of the connection unit 47 (for example, an AC plug) of the charging device 40 as a trigger.

First, a power supply function (the power storage unit 45) such as an electric double layer capacitor is mounted on the charging device 40. As a result, a power supply source to the control unit 63 (in particular, the charging control unit) of the moving body 60 and the control unit 43 (in particular, the charging control unit 433) of the charging device 40 is secured during power supply to the moving body 60. Thereby, even after the connection unit 47 (for example, an AC plug) of the charging device 40 is removed from the connection unit 52 (for example, an AC outlet) of the power supply facility 50, the charging control units of the moving body 60 and the charging device 40 can be driven, so that the charging control can be safely executed.

In addition, a sequence of releasing the lock mechanism of the connection unit 48 (for example, a connector conforming to CHAdeMO) of the charging device 40 can also be executed. As a result, the user can remove the connection unit 48 of the charging device 40 from the connection unit 61 (for example, an inlet conforming to CHAdeMO) of the moving body 60.

As the power supply function (the power storage unit 45) of the charging device 40, a power storage component such as an electric double layer capacitor or an electrolytic capacitor can be adopted. As the power supply function (the power storage unit 45) of the charging device 40, a secondary battery such as a lead storage battery, a lithium ion battery, a nickel-hydrogen battery, a nickel-cadmium battery, or an all-solid-state battery can also be adopted.

In addition, a lock mechanism may be provided in the connection unit 47 (for example, an AC plug) of the charging device 40 from the viewpoint of preventing electricity stealing and theft. In this case, the lock mechanism may be configured to be able to be unlocked with a physical key.

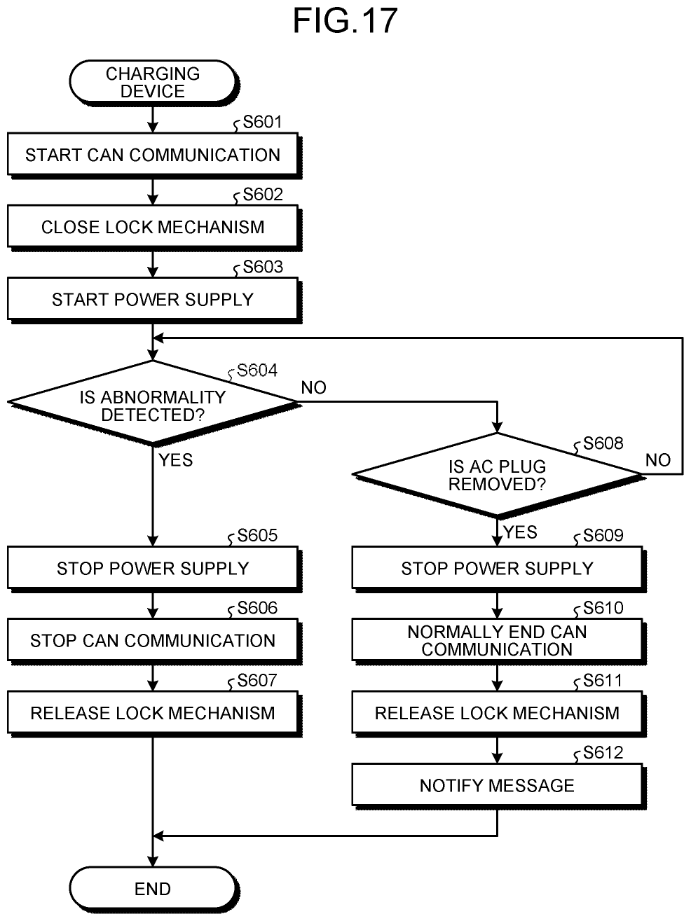

FIG. 17 is a flowchart illustrating the first charging control process. The first charging control process is executed by the charging device 40 with a power supply function. The first charging control process is executed, for example, when the connection unit 47 of the charging device 40 and the connection unit 52 of the power supply facility 50 are connected, and further, the connection unit 48 of the charging device 40 and the connection unit 61 of the moving body 60 are connected. Hereinafter, the first charging control process is described with reference to the flowchart of FIG. 17.

First, the charging device 40 starts CAN communication with the moving body 60 (Step S601). Then, the charging device 40 closes the lock mechanism of the connection unit 48 (for example, a connector conforming to CHAdeMO) (Step S602). Thereafter, the charging device 40 starts to supply DC power to the moving body 60 (Step S603). Then, the charging device 40 determines whether an abnormality is detected (Step S604).

When an abnormality is detected (Step S604: Yes), the charging device 40 stops power supply to the moving body 60 (Step S605) and further stops CAN communication with the moving body 60 (Step S606). Thereafter, the charging device 40 releases the lock mechanism of the connection unit 48 (Step S607) and ends the first charging control process.

However, when no abnormality is detected (Step S604: No), the charging device 40 determines whether the connection unit 47 (for example, an AC plug) is removed from the connection unit 52 (for example, an AC outlet) of the power supply facility 50 (Step S608). If not (Step S608: No), the charging device 40 returns the process to Step S604.

Meanwhile, when the connection unit 47 is removed from the connection unit 52 (Step S608: Yes), the charging device 40 executes the following process by using the power supply function. Specifically, the charging device 40 stops power supply to the moving body 60 (Step S609) and further normally ends CAN communication with the moving body 60 (Step S610). Thereafter, the charging device 40 releases the lock mechanism of the connection unit 48 (Step S611). Thereafter, the charging device 40 notifies the terminal device 30 operated by the user of a normal end message via the charging management server 10 (Step S612). When the notification is completed, the charging device 40 ends the first charging control process.

According to the first charging control process, power can be secured from the AC outlet of low power (for example, about 3 kW or less), and DC power can be supplied to the moving body 60 via the AC plug, the charging device 40, the connector conforming to CHAdeMO, and the inlet conforming to CHAdeMO. As a result, the user can use the standardized DC charging method conforming to CHAdeMO without using the AC normal charging method in which the original standards are scattered. As a result, since the operation procedure of charging can be unified, the user does not have to check the operation procedure every time charging is performed.

In addition, the user can control DC charging of the moving body 60 only by inserting and removing the AC outlet and the AC plug of the charging device 40. That is, the user can control the charging of the moving body 60 by the same operation procedure as the home appliance.

In addition, since power supply to the charging control unit can be secured by the power supply function in the charging device 40, the user can unlock the connector conforming to CHAdeMO even in a state where there is no power supply from the AC plug.

<4-2. Second Charging Control Process>

Next, the second charging control process is described.

In the second charging control process, a communication function (the communication unit 41) is mounted on the charging device 40, so that an operation to stop charging can be remotely executed by using a remote operation device such as the service server 20 or the terminal device 30.

Note that, as the communication function, in addition to long-distance communication such as NR or LPWA, short-range communication such as Wi-Fi or Bluetooth can be adopted. In addition, wired communication (for example, PLC) using a power line can also be adopted as the communication function.

Furthermore, as the terminal device 30, a general-purpose terminal (for example, a smartphone or a tablet) on which software such as a smartphone application or a web browser can be installed can be adopted. Furthermore, a dedicated terminal can be adopted as the terminal device 30.

As the service server 20, an IT system in API collaboration with the charging management server 10 can be adopted. For example, as the service server 20, a member information management server of a portable communication carrier company or the like, a management server of a subscription service for automobiles, or a power supply management server of an electric power company can be adopted.

In addition, a lock mechanism may be provided in the connection unit 47 (for example, an AC plug) of the charging device 40 from the viewpoint of preventing electricity stealing and theft. In this case, the lock mechanism may be configured to be able to be locked/unlocked with a communication function.

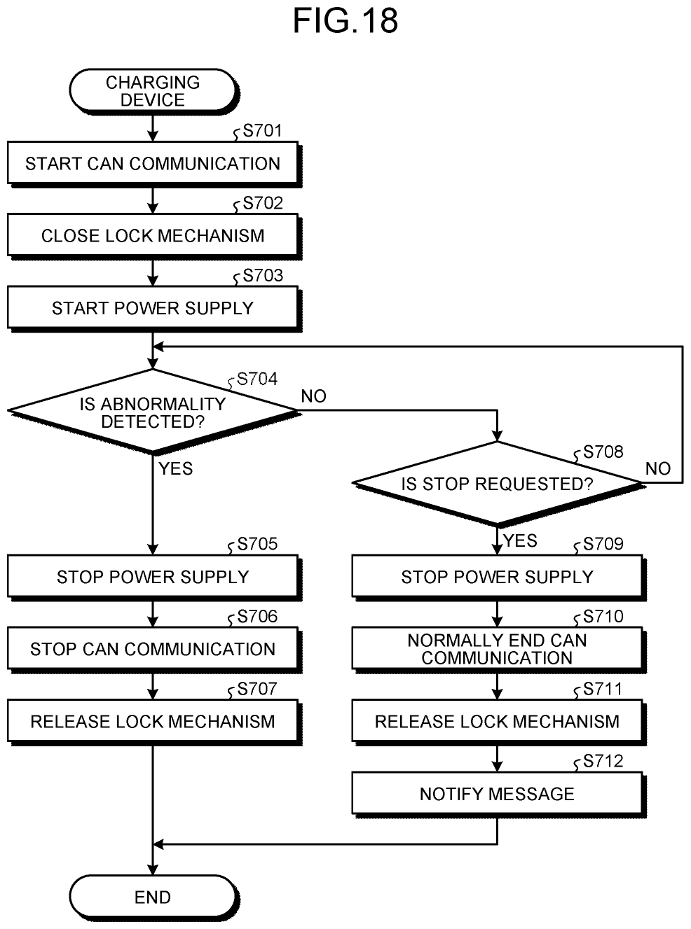

FIG. 18 is a flowchart illustrating the second charging control process. The second charging control process is executed by the charging device 40 with a communication function. The second charging control process is executed, for example, when the connection unit 47 of the charging device 40 and the connection unit 52 of the power supply facility 50 are connected, and further, the connection unit 48 of the charging device 40 and the connection unit 61 of the moving body 60 are connected. Hereinafter, the second charging control process is described with reference to the flowchart of FIG. 18.

First, the charging device 40 starts CAN communication with the moving body 60 (Step S701). Then, the charging device 40 closes the lock mechanism of the connection unit 48 (for example, a connector conforming to CHAdeMO) (Step S702). Thereafter, the charging device 40 starts to supply DC power to the moving body 60 (Step S703). Then, the charging device 40 determines whether an abnormality is detected (Step S704).

When an abnormality is detected (Step S704: Yes), the charging device 40 stops power supply to the moving body 60 (Step S705) and further stops CAN communication with the moving body 60 (Step S706). Thereafter, the charging device 40 releases the lock mechanism of the connection unit 48 (Step S707) and ends the second charging control process.

However, when no abnormality is detected (Step S704: No), the charging device 40 determines whether a charging stop request has been received from a remote operation device such as the service server 20 or the terminal device 30 (Step S708). The charging stop request may be operation information related to a remote operation of the user. If not (Step S708: No), the charging device 40 returns the process to Step S704.

Meanwhile, if receiving the charging stop request (Step S708: Yes), the charging device 40 stops the power supply to the moving body 60 (Step S709) and further normally ends the CAN communication with the moving body 60 (Step S710). Thereafter, the charging device 40 releases the lock mechanism of the connection unit 48 (Step S711). Thereafter, the charging device 40 notifies the terminal device 30 operated by the user of a normal end message via the charging management server 10 (Step S712). When the notification is completed, the charging device 40 ends the second charging control process.

According to the second charging control process, the user can remotely control the supply of DC power from the charging device 40 to the moving body 60 by using the remote operation device such as the service server 20 or the terminal device 30. In the current DC quick charger conforming to CHAdeMO, the user presses the stop button to start the power supply stop process, but the charging device 40 of the present embodiment can execute the power supply stop process even without the stop button.

While the user waits for the response message after issuing the power supply stop request, the charging device 40 normally ends the power supply to the moving body 60 and the CAN communication and then unlocks the connector conforming to CHAdeMO. While current DC quick chargers conforming to CHAdeMO can first unlock by pressing a stop button, the charging device 40 of the present embodiment can unlock without a stop button.

Even when the charging device 40 is charging the moving body 60, the user can safely stop the supply of the DV power from the charging device 40 to the EV by issuing the power supply stop request via the remote operation device.

<4-3. Third Charging Control Process>

Next, the third charging control process is described.

In the third charging control process, by mounting a communication function (the communication unit 41) on the charging device 40, it is possible to remotely execute not only stop of charging but also an operation such as pause/resume of charging, by using a remote operation device such as the service server 20 or the terminal device 30.

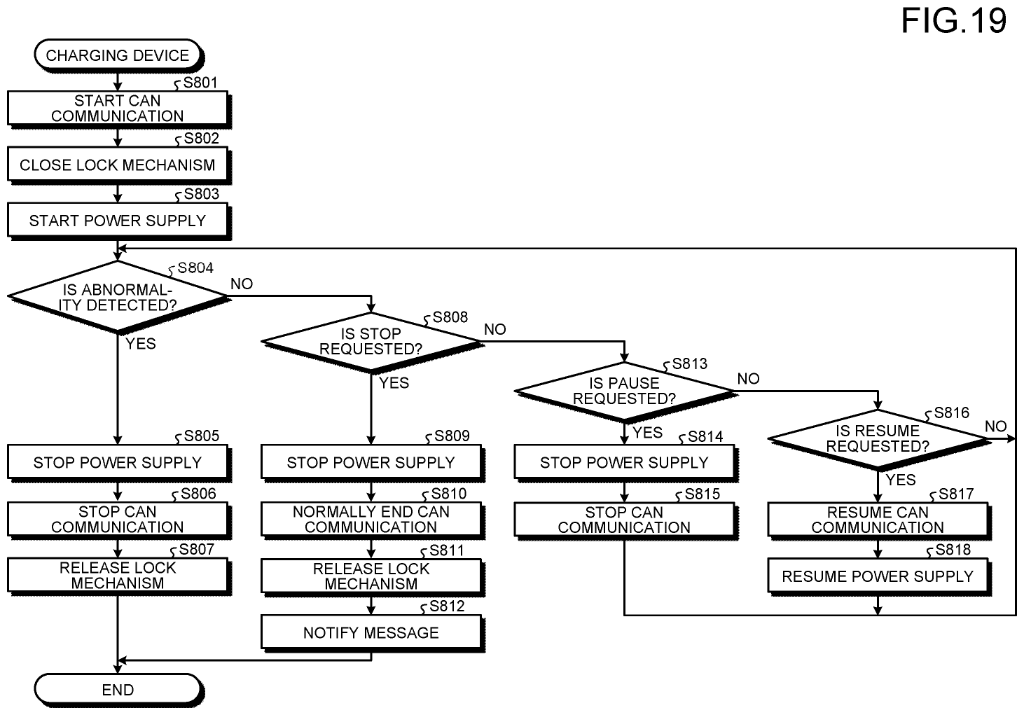

FIG. 19 is a flowchart illustrating the third charging control process. The third charging control process is executed by the charging device 40 with a communication function. The third charging control process is executed, for example, when the connection unit 47 of the charging device 40 and the connection unit 52 of the power supply facility 50 are connected, and further, the connection unit 48 of the charging device 40 and the connection unit 61 of the moving body 60 are connected. Hereinafter, the third charging control process is described with reference to the flowchart of FIG. 19.

First, the charging device 40 starts CAN communication with the moving body 60 (Step S801). Then, the charging device 40 closes the lock mechanism of the connection unit 48 (for example, a connector conforming to CHAdeMO) (Step S802). Thereafter, the charging device 40 starts to supply DC power to the moving body 60 (Step S803). Then, the charging device 40 determines whether an abnormality is detected (Step S804).

When an abnormality is detected (Step S804: Yes), the charging device 40 stops power supply to the moving body 60 (Step S805) and further stops CAN communication with the moving body 60 (Step S806). Thereafter, the charging device 40 releases the lock mechanism of the connection unit 48 (Step S807) and ends the third charging control process.

However, when no abnormality is detected (Step S804: No), the charging device 40 determines whether a charging stop request has been received from a remote operation device such as the service server 20 or the terminal device 30 (Step S808). The charging stop request may be operation information related to a remote operation of the user.

If receiving the charging stop request (Step S808: Yes), the charging device 40 stops the power supply to the moving body 60 (Step S809) and further normally ends the CAN communication with the moving body 60 (Step S810). Thereafter, the charging device 40 releases the lock mechanism of the connection unit 48 (Step S811). Thereafter, the charging device 40 notifies the terminal device 30 operated by the user of a normal end message via the charging management server 10 (Step S812). When the notification is completed, the charging device 40 ends the third charging control process.

However, when a charging stop request is not received (Step S808: No), the charging device 40 determines whether a charging pause request is received from the remote operation device (Step S813). The charging pause request may be operation information related to a remote operation of the user. If receiving the charging pause request (Step S813: Yes), the charging device 40 stops the power supply to the moving body 60 (Step S814) and further ends the CAN communication with the moving body 60 (Step S815). After the CAN communication ends, the charging device 40 returns the process to Step S804.

However, when the charging pause request is not received (Step S813: No), the charging device 40 determines whether a charging resume request is received from the remote operation device (Step S816). The charging resume request may be operation information related to a remote operation of the user. When the charging resume request is not received (Step S816: No), the charging device 40 returns the process to Step S804.

When receiving the charging resume request (Step S816: Yes), the charging device 40 resumes the CAN communication with the moving body 60 (Step S817) and further resumes the power supply to the moving body 60 (Step S818). After the power supply is resumed, the charging device 40 returns the process to Step S804.

According to the third charging control process, it is possible to remotely execute not only stop of charging but also operation such as pause/resume of charging.

### 5. SYSTEM COLLABORATION OF CHARGING INFRASTRUCTURE SERVICE

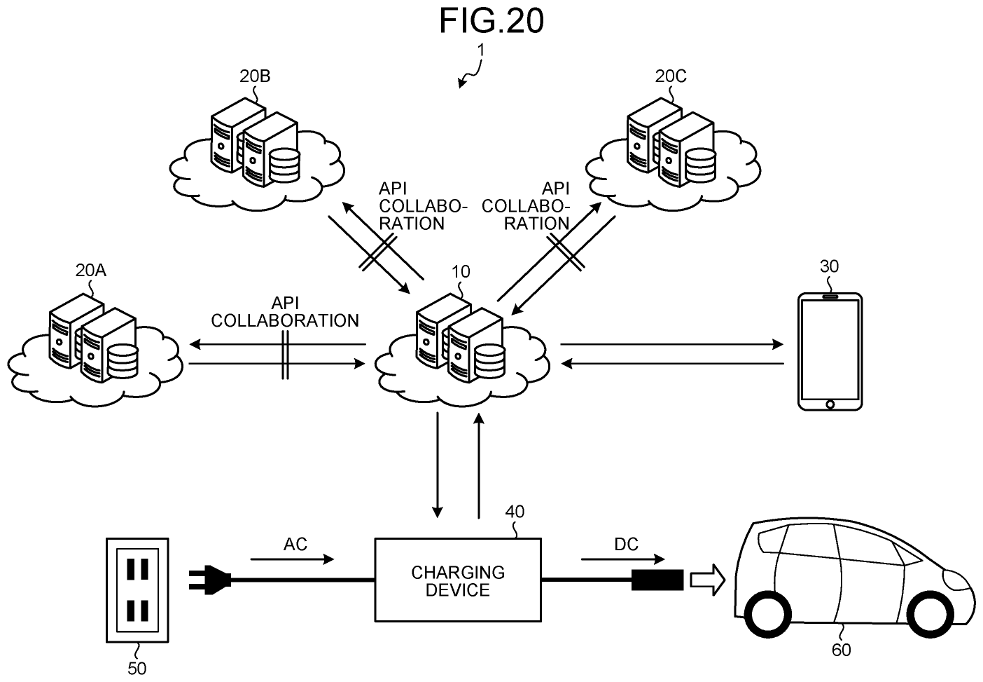

Various servers providing the charging infrastructure service may collaborate. FIG. 20 is a diagram illustrating system collaboration of the charging infrastructure service. In the example of FIG. 20, the charging management server 10 and the plurality of service servers 20 collaborate with each other. More specifically, the charging management server 10 and the power contractor management server 20A are in API collaboration, the charging management server 10 and the member information management server 20B are in API collaboration, and the charging management server 10 and the parking lot management server 20C are in API collaboration.

The various servers that provide the charging infrastructure service collaborate with each other, so that the charging system 1 expands user convenience. More specifically, the various servers may collaborate with each other as follows.

(1) Example of Collaboration Between the Charging Management Server 10 and the Member Information Management Server 20B

First, a case where the user uses a parking lot in a commercial establishment (or an affiliated parking lot of the corresponding commercial establishment) is described. In this case, the commercial establishment provides a service of electric power required for charging the moving body 60 according to purchase history information of the user. At that time, the commercial establishment side pays the electricity rate at the time of charging. In order to realize this, the charging management server 10 collaborates with the member information management server 20B of the commercial establishment to permit the user to perform charging. For example, the charging management server 10 permits charging using the power supply facility 50 and/or the charging device 40 in the corresponding parking lot.

(2) Example of Collaboration Between the Charging Management Server 10 and the Parking Lot Management Server 20C

Next, a case where the user uses a parking lot (for example, an hourly parking lot) other than the residence is described. In this case, a parking lot management company provides points and services based on the use history for the user. At that time, as a part of the service to the user, the parking lot management company pays the electricity rate at the time of charging. In order to realize this, the charging management server 10 collaborates with the parking lot management server 20C to permit charging based on the point information. For example, the charging management server 10 permits charging using the power supply facility 50 and/or the charging device 40 in the corresponding parking lot.

(3) Other Collaboration Examples

Next, a case where the user uses a public parking lot owned or controlled by a local public entity is described. In this case, an electricity rate at the time of charging by a local public entity is paid as a part of public service to the user. In order to realize this, the charging management server 10 collaborates with the service server 20 managed by the local public entity to permit the user to perform charging. For example, the charging management server 10 permits charging using the power supply facility 50 and/or the charging device 40 in the corresponding public parking lot.

### 6. METHOD OF USING CHARGING INFRASTRUCTURE SERVICE

Next, the following may be assumed as a method of using the charging infrastructure service. Hereinafter, an example of a method of using the charging infrastructure service is described.

First, the user searches for a parking lot near the destination where charging can be performed by using the app installed in the terminal device 30. Then, before using the charging infrastructure service, the user pre-reserves a time zone, a place of use, and a power consumption amount that the user wants to use by using the app.

Next, the user goes to the pre-reserved parking lot by the moving body 60. Then, the user stops the moving body 60 in the pre-reserved parking lot.

Next, the user connects the connection unit 47 (for example, an AC plug) of the charging device 40 and the connection unit 52 (for example, an AC outlet) of the power supply facility 50 arranged in the parking lot, and further connects the connection unit 48 (for example, a connector conforming to CHAdeMO) of the charging device 40 and the connection unit 61 (for example, an inlet conforming to CHAdeMO) of the moving body 60. At this time, the charging device 40 may be brought by the user or may be prepared in advance in the parking lot.

When the connection is completed, the user starts charging the moving body 60. Note that the charging device 40 may automatically start charging (power supply) according to the control of the charging management server 10 simultaneously with the connection. When charging is started, the charging management server 10 notifies the terminal device 30 of the start of charging. Then, the charging state is displayed on the app of the terminal device 30. For example, the fact that charging is being performed is displayed in the app of the terminal device 30.

When charging is completed, the charging device 40 notifies the charging management server 10 of charging completion. After receiving the notification of the end of charging, the charging management server 10 notifies the terminal device 30 of the end of charging and displays the charging state in the app of the terminal device 30. For example, the app of the terminal device 30 displays that charging is ended.

When the charging end is displayed in the app of the terminal device 30, the user removes the charging device 40 from the power supply facility 50 and the moving body 60 and stores the charging device 40 in the original place. When the storage is completed, the user departs from the parking lot.

Note that the app of the terminal device 30 may be configured such that the user can refer to the use history.

### 7. MODIFICATION

The embodiments described above are examples, and various modifications and applications are possible.

<7-1. Modification related to Charging Target>

For example, in the embodiments described above, the charging target of the charging device 40 is the moving body 60, but the charging target of the charging device 40 is not limited to the moving body 60. For example, the charging target of the charging device 40 may be a storage battery (a household storage battery or an office storage battery) installed in a house or an office in preparation for a power failure. In addition, the charging target of the charging device 40 may be a chargeable device installed in a structure.

The structure is, for example, a building such as a high-rise building, a house, a steel tower, a station establishment, an airport establishment, a harbor establishment, or a stadium. Note that the concept of a structure includes not only a building but also a construction (non-building structure) such as a tunnel, a bridge, a dam, a wall, or an iron pillar, and a facility such as a crane, a gate, or a windmill. In addition, the concept of the structure includes not only a structure on land (on the ground in a narrow sense) or under the ground but also a structure on water such as a platform or a megafloat and a structure under water such as a marine observation facility.

<7-2. Modification related to Charging Standard>

In the above embodiment, the charging standard corresponding to the charging device 40 and the charging target (for example, the moving body 60) is the CHAdeMO system, but the charging standard is not limited to the CHAdeMO system. The charging standard corresponding to the charging device 40 and the charging target may be a combined charging system (CCS), may be GB/T of China, or may be Supercharger (SC) of Tesla. In this case, the connection unit included in the charging device 40 and the charging target may conform to CCS, may conform to GB/T, or may conform to SC. The power supply operation (charging operation) of the charging circuit 46 and the charging control unit 433 of the charging device 40 is also appropriately changed in accordance with the charging standard.

<7-3. Modification related to Determination on Power Supply Availability>

Furthermore, in the embodiments described above, when the position of the charging device 40 does not match the registered position of the user, the charging management server 10 and/or the service server 20 determines power supply availability according to a predetermined condition. However, regardless of whether the position of the charging device 40 match the registered position of the user, the charging management server 10 and/or the service server 20 may determine power supply availability according to a predetermined condition.

In addition, in the embodiment described above, the charging management server 10 and/or the service server 20 determines power supply availability according to a predetermined condition by using the ID of the charging device 40. However, instead of the ID of the charging device 40, the charging management server 10 and/or the service server 20 may determine power supply availability with the ID of the moving body 60, the user ID of the power contractor management server 20A, the user ID of the member information management server 20B, the user ID of the parking lot management server 20C, or the like.

<7-4. Modification related to Position Information of Charging Device>

Furthermore, in the embodiment described above, the position information of the charging device 40 is the GPS information, but the position information is not limited to the GPS information. For example, the charging device 40 may determine the current position as the position information by the following methods (1) to (3). Note that the charging device 40 may determine the current position by combining a plurality of pieces of information selected from (1) to (3).

(1) Determination of a Current Position by Using a Plurality of Sensors

The charging device 40 may determine the current position by combining a plurality of sensors. For example, the current position as the position information may be determined in combination with a GPS sensor acceleration sensor. The accuracy of determining the current position can be improved. Note that the charging device 40 may determine the current position only by information of one sensor (for example, a GPS sensor).

(2) Determination of a Current Position by Using Wireless Communication

The charging device 40 may use wireless communication to determine the current position as the position information. For example, the charging device 40 may use information on the current position obtained through wireless communication such as LTE, NR, LPWA, Wi-Fi, or Bluetooth, as the position information. At this time, the charging device 40 may determine the current position based on identification information indicating with which base station (or access point) the communication is performed, position information indicating the installation position of the corresponding base station (or access point), and/or distance information indicating how far away from the corresponding base station (or access point). Here, as the distance information, for example, timing advance information is assumed. As a result, the accuracy of determining the current position can be improved.

(3) Determination of the Current Position by Direct Communication with the Power Supply Facility 50

Furthermore, the position information of the charging device 40 may be information indicating which the power supply facility 50 is positioned near among the plurality of power supply facilities 50. For example, a communication unit capable of communicating with other devices using Wi-Fi, Bluetooth, or the like is arranged in the power supply facility 50. Then, the charging device 40 determines which power supply facility 50 is positioned near by direct communication with the power supply facility 50. As a result, since it is possible to reliably know which power supply facility 50 is used by the user, erroneous billing can be prevented. For example, it is possible to prevent billing to an administrator who manages another power supply facility 50 near the power supply facility 50 used by the user.

<7-5. Other Modifications>

The control device that controls the charging management server 10, the service server 20, the terminal device 30, or the charging device 40 of the present embodiment may be realized by a dedicated computer system or may be realized by a general-purpose computer system.

For example, a communication program for performing the operation described above is stored and distributed in a computer-readable recording medium such as an optical disk, a semiconductor memory, a magnetic tape, or a flexible disk. Then, the control device is configured, for example, by installing the corresponding program in a computer and executing the processes described above. At this time, the control device may be a device (for example, a personal computer) outside the charging management server 10, the service server 20, the terminal device 30, and the charging device 40. Furthermore, the control device may be a device (for example, the control unit 13, the control unit 23, the control unit 33, or the control unit 43) inside the charging management server 10, the service server 20, the terminal device 30, or the charging device 40.

In addition, the communication program may be stored in a disk device included in a server device on a network such as the Internet and be downloaded to a computer. In addition, the functions described above may be realized in cooperation with an operating system (OS) and application software. In this case, a part other than the OS may be stored in a medium and distributed, or a part other than the OS may be stored in a server device and be downloaded to a computer.

Among the processes described in the above embodiments, all or a part of the processes described as being performed automatically can be performed manually, or all or a part of the processes described as being performed manually can be performed automatically by a known method. In addition, the processing procedure, specific names, and information including various data and parameters disclosed in the document and the drawings can be arbitrarily changed unless otherwise specified. For example, the various types of information illustrated in each figure are not limited to the illustrated information.

In addition, each component of each device illustrated in the drawings is functionally conceptual and is not necessarily physically configured as illustrated in the drawings. That is, a specific form of distribution and integration of each device is not limited to the illustrated form, and all or a part thereof can be configured to be functionally or physically distributed and integrated in an arbitrary unit according to various loads, usage statuses, and the like.

In addition, the embodiments described above can be appropriately combined in a region in which the processing contents do not contradict each other. Furthermore, the order of each step illustrated in the flowchart according to the embodiment described above can be changed as appropriate.

Furthermore, for example, the present embodiment can be implemented as any configuration constituting a device or a system, for example, a processor as a system large scale integration (LSI) or the like, a module using a plurality of processors or the like, a unit using a plurality of modules or the like, a set obtained by further adding other functions to a unit, or the like (that is, a configuration of a part of the device).

Note that, in the present embodiment, the system means a set of a plurality of components (such as devices or modules (parts)), and it does not matter whether all the components are in the same housing. Therefore, a plurality of devices that are stored in separate housings and connected via a network and one device in which a plurality of modules are stored in one housing are both systems.

Furthermore, for example, the present embodiment can adopt a configuration of cloud computing in which one function is shared and processed by a plurality of devices in cooperation via a network.

### 8. CONCLUSION

As described above, according to the embodiment of the present disclosure, since the power supply of the charging device 40 is controlled from an external device (for example, the charging management server 10), the user can charge the moving body 60 by using the existing power supply facility 50. That is, since it is not necessary to newly prepare an expensive power supply facility in order to charge the moving body 60, a charging environment of the moving body 60 can be realized at a low cost. In addition, since the charging device 40 can be carried to a place where there is a power supply facility 50, the user does not take a labor of checking availability of the service and an operation procedure each time the charging is performed.

In addition, since it is not necessary to newly prepare an expensive power supply facility for charging the moving body 60, the establishment owner or the facility administrator can provide the charging infrastructure service to the user only by opening the AC outlet in the establishment without installing the CHAdeMO DC quick charger or the AC normal charger.

In addition, the charging management server 10 and/or the service server 20 determines power supply availability according to a condition determined by an administrator of the power supply facility 50. Therefore, for example, when the power supply facility 50 is released to the user for free as an establishment use service, the establishment owner or the facility administrator applies to the charging management server 10 for the condition of the power supply permission, so that the power supply to the charging device 40 can be set to be always permitted.

In addition, the charging management server 10 and/or the service server 20 determines whether the position of the charging device 40 matches the registered position (address on the power contract) of the user in the determination of power supply availability. Therefore, when the position of the charging device 40 matches the registered position of the user, the user does not need to check availability of the service or start procedure for each place of use as in the current charging infrastructure service.

In addition, the charging management server 10 and/or the service server 20 can identify which power supply facility 50 is used by the user based on the position information of the charging device 40. In addition, the charging management server 10 bills the user in collaboration with the service server 20. Therefore, even when the position of the charging device 40 does not match the registered position of the user, the user can charge the moving body 60 without being conscious of the payment procedure only by connecting the connection unit 47 (for example, an AC plug) of the charging device 40 and the connection unit 52 (for example, an AC outlet) of the power supply facility 50 and connecting the connection unit 48 (for example, a connector) of the charging device 40 and the connection unit 61 (for example, the inlet) of the moving body 60.

In addition, the charging management server 10 and/or the service server 20 bills the user in collaboration with the power contractor management server 20A. Therefore, the user can collectively pay the electricity rate required for charging together with the power consumption amount of the contract address.

In addition, the charging management server 10 and/or the service server 20 can identify which power supply facility 50 is used by the user based on the position information of the charging device 40. Therefore, even if the power supply facility 50 of an establishment in a place other than the address on the power contract of the user is used, the establishment owner or the establishment administrator is not billed for the electricity rate used by the user.

In addition, the charging management server 10 and/or the service server 20 does not permit the power supply continuation of the charging device 40 when the surplus power is small. As a result, charging when surplus power of a power generation facility such as an electric power company is small is suppressed. In other words, surplus power of a power generation facility such as an electric power company is used. As a result, the supply and demand balance of power supply is maintained.

In addition, the charging management server 10 and/or the service server 20 uses history information indicating whether the right to use power is secured for determination of power supply availability. By utilizing the power future transaction, the power generation amount in the planned power generation of power can be calculated, so that the establishment administrator can efficiently operate assets such as the power supply facility 50.

Although each embodiment of the present disclosure has been described above, the technical scope of the present disclosure is not limited to the embodiments described above as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be provided.

Note that the present technology can also have the following configurations.

(1)

An information processing device including:
an acquisition unit that acquires information related to a charging device that receives power from a power supply facility and supplies the power, the charging device being separated from the power supply facility;
a determination unit that determines permission or non-permission of the power supply of the charging device based on the information related to the charging device; and
a transmission unit that transmits information related to a determination result of permission or non-permission of the power supply to the charging device or another device that controls the charging device.
   (2)

The information processing device according to (1),
wherein the acquisition unit acquires position information of the charging device as the information related to the charging device, and
the determination unit determines permission or non-permission of the power supply of the charging device based on the position information of the charging device.
   (3)

The information processing device according to (2),
wherein the acquisition unit acquires registered position information related to a user associated with the charging device in addition to position information of the charging device, and
the determination unit determines permission or non-permission of the power supply based on the position information of the charging device and the registered position information.
   (4)

The information processing device according to (3),
wherein the acquisition unit acquires address information on a power contract of the user as the registered position information, and
the determination unit determines to permit the power supply when it is determined that the charging device is positioned at the address on the power contract of the user.
   (5)

The information processing device according to (4),
wherein the determination unit determines permission or non-permission of the power supply according to a predetermined condition, when it is determined that the charging device is not positioned at the address on the power contract of the user.
   (6)

The information processing device according to (5),
wherein the predetermined condition includes at least a first condition determined by an administrator of the power supply facility to be used by the user, and
the determination unit determines whether a current state satisfies the first condition when it is determined that the charging device is not positioned at the address on the power contract of the user and determines to permit the power supply when the current state satisfies the first condition.
   (7)

The information processing device according to (5) or (6),
wherein the predetermined condition includes at least a second condition determined by the user, and
the determination unit determines whether a current state satisfies the second condition when it is determined that the charging device is not positioned at the address on the power contract of the user and determines to permit the power supply when the current state satisfies the second condition.
   (8)

The information processing device according to any one of (5) to (7),
wherein the acquisition unit acquires contract information of the user related to use of the power supply facility,
the predetermined condition includes at least a third condition related to a contract for using the power supply facility, and
the determination unit determines whether the contract of the user satisfies the third condition when it is determined that the charging device is not positioned at the address on the power contract of the user and determines to permit the power supply when the contract of the user satisfies the third condition.
   (9)

The information processing device according to any one of (2) to (8),
wherein the acquisition unit acquires position information of the power supply facility in addition to the position information of the charging device, and
the determination unit determines permission or non-permission of the power supply of the charging device based on the position information of the charging device and the position information of the power supply facility.
   (10)

The information processing device according to any one of (2) to (9),
wherein the determination unit determines not to permit the power supply of the charging device when surplus power of a jurisdiction area of an electric power company where the charging device is positioned falls below a predetermined threshold value.
   (11)

The information processing device according to any one of (1) to (10),
wherein the determination unit determines permission or non-permission of continuation of the power supply in addition to the determination on permission or non-permission of a start of the power supply.
   (12)

The information processing device according to (11),
wherein the acquisition unit acquires information on a power consumption amount of the charging device as the information related to the charging device, and
the determination unit determines permission or non-permission of continuation of the power supply based on the information on the power consumption amount of the charging device.
   (13)

The information processing device according to (12),
wherein the acquisition unit acquires reservation information of a power consumption amount from a user associated with the charging device, and
the determination unit determines not to permit continuation of the power supply when the power consumption amount of the charging device reaches a power amount reserved by the user.
   (14)

The information processing device according to any one of (11) to (13),
wherein the acquisition unit acquires information indicating that an abnormality occurs in the charging device as the information related to the charging device, and
the determination unit determines not to permit continuation of the power supply when an abnormality occurs in the charging device.
   (15)

A charging device that receives power from a power supply facility and supplies the power, the charging device being separated from the power supply facility and including:
a transmission unit that transmits information related to the charging device to an information processing device that transmits control information for controlling the power supply of the charging device;
a reception unit that receives, from the information processing device, information related to a determination result of permission or non-permission of the power supply, the determination result being based on the information related to the charging device; and
a charging control unit that controls on/off of the power supply based on information related to the determination result.
   (16)

The charging device according to (15),
wherein the information processing device is configured to determine permission or non-permission of the power supply of the charging device based on position information of the charging device, and
the transmission unit transmits the position information of the charging device to the information processing device as the information related to the charging device.
   (17)

The charging device according to (15) or (16),
wherein the reception unit receives information related to a determination result of permission or non-permission of continuation of the power supply in addition to information related to a determination result of permission or non-permission of a start of the power supply, and
the charging control unit stops the power supply when continuation of the power supply is not permitted.
   (18)

The charging device according to any one of (15) to (17), further including:
a power storage unit that stores a predetermined amount of power,
wherein the charging control unit performs a power supply stop process by using the power stored in the power storage unit when connection with the power supply facility is cut off before the power supply stop process.
   (19)

The charging device according to any one of (15) to (18),
wherein the reception unit receives operation information related to a remote operation of a user, and
the charging control unit executes a process of stopping, pausing, or resuming the power supply based on the operation information.
   (20)

A charging system including:
a charging device that receives power from a power supply facility and supplies the power, the charging device being separated from the power supply facility; and
an information processing device directly or indirectly connected to the charging device via a network, wherein
the information processing device includes:
an acquisition unit that acquires information related to the charging device;
a determination unit that determines permission or non-permission of the power supply of the charging device based on the information related to the charging device; and
a transmission unit that transmits information related to a determination result of permission or non-permission of the power supply to the charging device or another device that controls the charging device, and
the charging device includes:
a reception unit that receives the information related to the determination result from the information processing device or the another device; and
a charging control unit that controls on/off of the power supply based on the information related to the determination result.

### REFERENCE SIGNS LIST

1 CHARGING SYSTEM
10 CHARGING MANAGEMENT SERVER
20 SERVICE SERVER
20A POWER CONTRACTOR MANAGEMENT SERVER
20B MEMBER INFORMATION MANAGEMENT SERVER
20C PARKING LOT MANAGEMENT SERVER
30 TERMINAL DEVICE
40 CHARGING DEVICE
50 POWER SUPPLY FACILITY
60 MOVING BODY
11, 21, 31, 41 COMMUNICATION UNIT
12, 22, 32, 42 STORAGE UNIT
13, 23, 33, 43, 63 CONTROL UNIT
44 SENSOR UNIT
45, 62 POWER STORAGE UNIT
46 CHARGING CIRCUIT
47, 48, 52, 61 CONNECTION UNIT
51 POWER SUPPLY CIRCUIT
64 MOTIVE POWER UNIT
131, 231, 431 TRANSMISSION UNIT
132, 232, 432 RECEPTION UNIT
133, 233 ACQUISITION UNIT
134, 234 DETERMINATION UNIT
433 CHARGING CONTROL UNIT

1. An information processing device including:
an acquisition unit that acquires information related to a charging device that receives power from a power supply facility and supplies the power, the charging device being separated from the power supply facility;
a determination unit that determines permission or non-permission of the power supply of the charging device based on the information related to the charging device; and
a transmission unit that transmits information related to a determination result of permission or non-permission of the power supply to the charging device or another device that controls the charging device.

2. The information processing device according to claim 1,
wherein the acquisition unit acquires position information of the charging device as the information related to the charging device, and
the determination unit determines permission or non-permission of the power supply of the charging device based on the position information of the charging device.

3. The information processing device according to claim 2,
wherein the acquisition unit acquires registered position information related to a user associated with the charging device in addition to position information of the charging device, and
the determination unit determines permission or non-permission of the power supply based on the position information of the charging device and the registered position information.

4. The information processing device according to claim 3,
wherein the acquisition unit acquires address information on a power contract of the user as the registered position information, and
the determination unit determines to permit the power supply when it is determined that the charging device is positioned at the address on the power contract of the user.

5. The information processing device according to claim 4,
wherein the determination unit determines permission or non-permission of the power supply according to a predetermined condition, when it is determined that the charging device is not positioned at the address on the power contract of the user.

6. The information processing device according to claim 5,
wherein the predetermined condition includes at least a first condition determined by an administrator of the power supply facility to be used by the user, and
the determination unit determines whether a current state satisfies the first condition when it is determined that the charging device is not positioned at the address on the power contract of the user and determines to permit the power supply when the current state satisfies the first condition.

7. The information processing device according to claim 5,
wherein the predetermined condition includes at least a second condition determined by the user, and
the determination unit determines whether a current state satisfies the second condition when it is determined that the charging device is not positioned at the address on the power contract of the user and determines to permit the power supply when the current state satisfies the second condition.

8. The information processing device according to claim 5,
wherein the acquisition unit acquires contract information of the user related to use of the power supply facility,
the predetermined condition includes at least a third condition related to a contract for using the power supply facility, and
the determination unit determines whether the contract of the user satisfies the third condition when it is determined that the charging device is not positioned at the address on the power contract of the user and determines to permit the power supply when the contract of the user satisfies the third condition.

9. The information processing device according to claim 2,
wherein the acquisition unit acquires position information of the power supply facility in addition to the position information of the charging device, and
the determination unit determines permission or non-permission of the power supply of the charging device based on the position information of the charging device and the position information of the power supply facility.

10. The information processing device according to claim 2,
wherein the determination unit determines not to permit the power supply of the charging device when surplus power of a jurisdiction area of an electric power company where the charging device is positioned falls below a predetermined threshold value.

11. The information processing device according to claim 1,
wherein the determination unit determines permission or non-permission of continuation of the power supply in addition to the determination on permission or non-permission of a start of the power supply.

12. The information processing device according to claim 11,
wherein the acquisition unit acquires information on a power consumption amount of the charging device as the information related to the charging device, and
the determination unit determines permission or non-permission of continuation of the power supply based on the information on the power consumption amount of the charging device.

13. The information processing device according to claim 12,
wherein the acquisition unit acquires reservation information of a power consumption amount from a user associated with the charging device, and
the determination unit determines not to permit continuation of the power supply when the power consumption amount of the charging device reaches a power amount reserved by the user.

14. The information processing device according to claim 11,
wherein the acquisition unit acquires information indicating that an abnormality occurs in the charging device as the information related to the charging device, and
the determination unit determines not to permit continuation of the power supply when an abnormality occurs in the charging device.

15. A charging device that receives power from a power supply facility and supplies the power, the charging device being separated from the power supply facility and including:
a transmission unit that transmits information related to the charging device to an information processing device that transmits control information for controlling the power supply of the charging device;
a reception unit that receives, from the information processing device, information related to a determination result of permission or non-permission of the power supply, the determination result being based on the information related to the charging device; and
a charging control unit that controls on/off of the power supply based on information related to the determination result.

16. The charging device according to claim 15,
wherein the information processing device is configured to determine permission or non-permission of the power supply of the charging device based on position information of the charging device, and
the transmission unit transmits the position information of the charging device to the information processing device as the information related to the charging device.

17. The charging device according to claim 15,
wherein the reception unit receives information related to a determination result of permission or non-permission of continuation of the power supply in addition to information related to a determination result of permission or non-permission of a start of the power supply, and
the charging control unit stops the power supply when continuation of the power supply is not permitted.

18. The charging device according to claim 15, further including:
a power storage unit that stores a predetermined amount of power,
wherein the charging control unit performs a power supply stop process by using the power stored in the power storage unit when connection with the power supply facility is cut off before the power supply stop process.

19. The charging device according to claim 15,
wherein the reception unit receives operation information related to a remote operation of a user, and
the charging control unit executes a process of stopping, pausing, or resuming the power supply based on the operation information.

20. A charging system including:
a charging device that receives power from a power supply facility and supplies the power, the charging device being separated from the power supply facility; and
an information processing device directly or indirectly connected to the charging device via a network, wherein
the information processing device includes:
an acquisition unit that acquires information related to the charging device;
a determination unit that determines permission or non-permission of the power supply of the charging device based on the information related to the charging device; and
a transmission unit that transmits information related to a determination result of permission or non-permission of the power supply to the charging device or another device that controls the charging device, and
the charging device includes:
a reception unit that receives the information related to the determination result from the information processing device or the another device; and
a charging control unit that controls on/off of the power supply based on the information related to the determination result.
